(19) United States
(12) Patent Application Publication
(10) Pub. No.: US 2026/0153166 A1
(43) Pub. Date: Jun. 4, 2026

(54) Cable Stabilizing Device for Use in a Subsea System

(71) Applicant: Henrik Bang-Andreasen, Bergen (NO)

(72) Inventor: Henrik Bang-Andreasen, Bergen (NO)

(21) Appl. No.: 18/717,440

(22) PCT Filed: Mar. 7, 2024
(86) PCT No.: PCT/NO2024/050058

§ 371 Date: Jun. 7, 2024

(30) Foreign Application Priority Data
Mar. 7, 2023 (NO) 20230240

(51) Int. Cl. E21B 17/01; F16L 1/12

(52) U.S. Cl. CPC F16L 3/04; H02G 9/02

(57) ABSTRACT

A stabilizing device for a subsea cable unit is disclosed where the stabilizing device extends between the seabed and a cable entrance on a subsea structure where the cable entrance is located above the seabed. The subsea cable unit comprises a subsea cable with a cable protective system or a subsea cable only, and the stabilizing device comprises at least one stabilization base and at least one pile element for anchoring of the at least one stabilization base to the seabed or a scour protection layer. The at least one pile element being adapted to be driven into the seabed or scour protection layer such that the at least one stabilization base is securely anchored to the seabed.

### TECHNICAL FIELD

The present invention is related to a stabilizing device and a subsea system for stabilizing cables and a cable protection system in a subsea environment.

### BACKGROUND OF THE DISCLOSURE

The fixed foundation offshore wind industry has developed a set of state-of-the-art methodologies relating to the cables, such as the installation and protection of the cables. For many good reasons, cost being just one of these, the industry has pursued static cable designs to be used for what is known as the inter array grid. This is cables interconnecting individual wind turbine generators (WTG's) and transformer stations (substations). Also, the export cables from offshore substations or land-fall cables connecting to on-shore substations are based on static cable designs. These static cable designs can operate with very limited movements (i.e. dynamics). Such movements are typically restricted mostly to reeling or spooling during the manufacturing and installation phase, in addition to very limited movement during the operational power generating phase (typically between 20 and 40 years) and decommissioning phase at the end of offshore leases.

The static cable design's limited dynamic life is defined by cable design limits, and for repeated movement (dynamics) a set of curvatures and tension parameters defines the fatigue-life of the cable designs. The more dynamic (increased curvature and/or increased tension) a cable is exposed to-the shorter the cable fatigue-life will be.

Installing and operation of the cables has proven difficult without protecting the cables when handled during pull-in operation and in operation when exposed to accelerated water particle velocities (current flows).

The state-of-the-art cable protection of the industry is to bury cables into seabed between foundations. In addition to adhering to existing rules and regulations, the industry has also set up several standards and recommended practices.

From early on, wind turbine generators had J-tubes as standard for cables, but due to economics the designs for monopiles without J-tubes (known as J-tubeless) have been pursued, where an aperture hole in the monopile wall is used to mechanically connect a so-called “Cable Protection System.”

To provide stabilization of the cable inside the cable protection system in the trajectory between the aperture hole of a J-tubeless monopile or the bell-mouth of any J-tube, and the seabed, was the intended primary feature of the cable protection system. However, the cable protection system that is exposed to the accelerated water particle velocities is not stable and can move. Various bending strain management or restriction solutions in the cable protection system, reduces the mobility of the cable protection system, but it moves cyclically, and as a result the cable enclosed inside is forced to move with the cable protection system.

The cable protection system is forced to move with surrounding water particles that are accelerated by metocean conditions (meteorological-and-oceanic conditions, e.g., wind, waves and currents). Through 2020 and 2021, it was believed that software like ORCAFLEX® was able to model the conditions and provide a realistic scenario with regard to the scale and impact of the water particle flow velocities.

The cable protection system is modeled in such software such that the trajectory of the cable protection system between Monopile aperture, or J-Tube bellmouth, over touch down to seabed or scour protection in effect is a catenary, and thereafter continuing over scour-protection/seabed to a burial point in the seabed. The forces act primarily on the catenary because water particle velocities are highest closest to the foundation and lower at the seabed burial point farther away from the foundation. Worst case scenario is generated in a most “Extreme Sea State,” which is represented as the “Ultimate Limit State” the dynamically generated highest tension and most severe bending of the cable protection system.

These dynamic forces are present as tension in the seabed part of the cable protection system. For the cable protection system to remain in position, an anchoring strength larger than the highest potential tension (from calculated Ultimate Limit State) is required. This anchoring strength is referred to as “hold-back-capacity” and requires that a part of the cable protection system is buried in the seabed. The density or friction of the seabed and seabed features will dictate how long this length of seabed needs to be. The modelled hold-back-capacity (assumed value to be used in the analysis) requires that the seabed features are known and remains unchanged (i.e., the seabed features are constant or better).

The procedures that are used today principally follow a track where cable protection system suppliers must carry out an analysis (using ORCAFLEX® or a similar software) demonstrating that:
a) the cable design limits (minimum bend radius and tension) is not compromised, and
b) the cable fatigue-life is above project life cycle (typically with a safety factor of 10, so a 32-year project requires minimum 320 years cable-fatigue-life).

From 2019 an alarming number of failing cable protection system and few failing cables were discovered. These can be categorized as both environmental and engineering driven.

On the environmental side two important factors stand out.
1) The acceleration of water particles around the vertical foundation is more severe than forecasted through the analysis. A proof of this exists also from scour-protection, where in the last years D-90 stones have been proposed (typically 275 kg in air) while only 6-7-years ago D-30 stones (typically 50 kg in air) sufficed.
2) The other, and for this invention equally important, environmentally driven factor, is the seabed features. The seabed features in the upper two to three meters of the seabed were generally not know in the 2010s, and from 2017-2018 known from Cone Penetration Tests (CPT) campaigns.

The CPT serves as an important tool for the cable burial risk assessment (CBRA), which focuses mainly on burial depth below existing/virgin seabed, providing foresight on that minimum Depth-of-Lowering of the cable below virgin seabed level.

The cone penetration test serves at best as a misleading measure to make assessments of what the impact of seabed features on the buried part of the cable protection system will be. The reason being that the virgin seabed (from which the CPT data are obtained) is disturbed during installation and burial activities. Hence the assessment that leads to the analysis for the cable protection system buried part is based on a model where the analysis must assume and set parameters for soil spring features and hold-back-capacity. Even if this assumed value is not optimistically chosen to allow the analysis to pass, there is no practical way this can be verified.

In addition to the seabed features, the installation tolerances further increase the uncertainty regarding where the point of burial of the cable protection system relative to the foundation is. This amplifies the uncertainty of qualified assumptions without a finite seabed feature/soil-spring-seabed interface or a precise position of where this soil-spring is positioned at installation.

On top of these uncertainties, there are future unknown changes over the operational life of the cable protection system.

Up till 2021 at least a large portion of analysis suggested that the backfill on top of the cable protection system resembled virgin seabed (compressed solids) when filled to the top of the trench (which at best is assuming far higher ballasting weights and unrealistic cover of the cable protection system and/or cable than is actually the case). Furthermore, amplified by an often less than assumed burial angle, the anchoring strength of the cable protection system is assumed higher than what is conservatively accounted for, and further away from the wind turbine generator or substation structure.

These two environmental conditions both facilitated and amplified the mobility of the cable protection system on scour-protection and/or seabed, i.e., the analysis which has been presented as a “conservative model”, provides unrealistically low mobility of the cable protection system. As a result, the cable protection system is behaving more dynamically, forcing the cable to higher curvatures and tensions (which shortens cable fatigue-life and may breach cable design limits). The increased curvature and tension in the cable protection system loads seabed interface soil spring more severely and hold-back-capacity with higher forces. Thus, the tension in the cable protection system overcomes the anchoring hold-back-capacity and pulls the buried part of the cable protection system from its buried position. This results in that a longer section of cable protection system is exposed to dynamics and mobility, transferring higher tensions to the cable under more severe curvature.

Further, a series of engineering flaws have worsened these problems. One being the use of bend restrictors, which by API-17 ((Specification for Flexible Pipe Ancillary Equipment and Recommended Practice for Flexible Pipe Ancillary Equipment (the recommended practices for flexible elements from the American Petroleum Institute)), is strictly for static sections but is not limited to the “static” part of a steep or lazy loop flexible riser, where the dynamic from topside isolates above a subsea float, and the seabed touch down is without surface metocean influence.

Analysis assumes that the train of bend restrictors performs as a uniform vertebra. Hence, the analysis distributes all movement over the full train, when, in fact, the small differences between each link will make the interlink with least friction act first and most. Secondly, when the train of bend restrictors is pulled over the scour-protection and/or seabed, it rolls. Repeated movements reduce the initial friction (between links), and the train of bend restrictors becomes circular wheel-like structures that rolls over the scour-protection and/or seabed, with less and less friction.

This action along with the designers and analysis expectations of a “clean seawater environment” inside the cable protection system prevents the understanding that in the turbid seawater near the seabed, the silt and sand particles act very abrasively. In fact, the rotation of the bend restrictors with a highly abrasive mixture of sand and silt inside, grinds down not just the Bend Restrictors but also the cables from within the cable protection system.

The findings of these failures prompted the industry, in particular ORSTED® during 2021 and 2022, to stabilize the cable protection systems to prevent cable protection system and cable mobility. ORSTED® stabilized a total of five wind parks equipped with cable protection system designs based on bend restrictors.

With this background, in 2022 the insurance industry serving the offshore wind industry claimed mandatory “stabilization” of cable protection system and cable before new insurance policies could be issued.

While stabilization with rocks solves the cable protection system mobility on scour-protection and/or seabed, it does change the conditions for the cable protection system. The trajectory on seabed is stabilized, but the catenary part is still in a dynamic environment. While the mobility is removed from the part of cable protection system under the rocks, the features and position of the coil-spring model remains uncertain. Pinning of the cable protection system under the stabilization, increases the bending moment in the local area of pinning. With the cable protection system and the cable pinned under the stabilization ballast, the localized bending moment and tensions in the pinning point or area is increased. This reduces the cable-fatigue-life and challenge the cable protection system with unaccounted for bending moments.

Another aspect of stabilizing the cable or cable protection system and cable, is the cost of the stabilization materials and the installation. The costs of stabilization materials and the installation varies, but it is estimated to have a cost of three to five times the cost of a cable protection system in the North Sea region of Europe. This cost is approximately three-times higher in US regions and approximately six times higher in APAC region.

In the already strained offshore logistic operation of building a wind park, the stabilization will need to be in place at a relatively short time after cable pull-in. This adds risks, complexity, and costs to the installation procedure. Most developers will prioritize the heavy lifting operations, stabilization will prolong the operation and the risk is that the cable protection system and the cables are severely fatigued before they are stabilized.

### SUMMARY OF THE DISCLOSURE

Thus, an object of the present invention has been to provide stabilization of a cable protection system and/or a cable which removes risks of seabed features or seabed changes.

It has also been an object to provide stabilization of a cable protection system and/or a cable with a bending management system to remove risks that cable-fatigue-life is compromised (i.e., decreasing risk of cable failures during operational life of the cable).

Another object has been to provide stabilization within the cable-pull-in sequence.

Yet another object has been to provide stabilization of a cable protection system and/or a cable without use of ballast materials (such as rock, rock-filter-bags, mattresses, etc.)

Yet another object has been to provide stabilization of a cable protection system and/or a cable without the use of cranes and lifting operations.

Yet another object has been to provide stabilization of a cable protection system and/or a cable with no proximity to wind turbines generators or substations.

Yet another object has been to provide a wide berth of tolerance for positioning of a stabilizing device for cable protection system and/or a cable.

These objectives are met with a stabilizing device as defined in claim 1 and a subsea system as defined in claim 20 and a use of a stabilizing device and the subsea system as defined in claim 25. Further embodiments of the present invention are defined in the dependent claims.

Hence, there is provided a stabilizing device for a subsea cable unit extending between the seabed and a cable entrance on a subsea structure where the cable entrance is located above the seabed, wherein the subsea cable unit comprises a subsea cable with a cable protective system or a subsea cable only, and wherein the stabilizing device comprises:
at least one stabilization base,
a pile element for anchoring of the at least one stabilization base to the seabed, the pile element being adapted to be driven into the seabed such that the at least one stabilization base can be securely anchored to the seabed,
a first clamping device which is securely attached to the at least one stabilization base in one end, the first clamping device being curved and adapted to at least partially surround the subsea cable unit and hold the subsea cable unit when the stabilizing device and the subsea cable unit are installed, and
a second clamping device which is securely attached to the stabilization base in one end, the second clamping device being curved and adapted to at least partially surround the subsea cable unit and hold the subsea cable unit when the stabilizing device and the subsea cable unit are installed.

The first clamping device and the second clamping device may be attached to the stabilization base so that the first clamping device is closer to the subsea structure than the second clamping device, and wherein the first clamping device is flexible.

Preferably, the second clamping device is more rigid than the first clamping device.

The at least one stabilization base preferably comprises at least one through-hole through which the pile element is adapted to be passed.

The stabilizing device preferably comprises at least one bracket arrangement which comprises at least one through-hole for the pile element.

The pile element may be provided with an expansion device which exerts a force on the at least one stabilization base towards the seabed.

The expansion device is preferably adapted to expand if the seabed is eroded in order to exert a continuous force on the at least one stabilization base towards the seabed.

The expansion device may, for example, comprise a spring element.

Alternatively, the expansion device comprises a hydraulic element.

Alternatively, the expansion device also comprises a swelling element which swells in water.

The pile element may be provided with an adjustment device for adjustment of the tension in the spring element and thereby the force exerted on the at least one stabilization base.

Preferably, the stabilizing device further comprises a cowl unit for bending control of the subsea cable unit, wherein the cowl is curved and at least partially surrounds the subsea cable unit in a circumferential direction of the subsea cable unit, and the cowl unit and the subsea cable unit is held by the first clamping device and the second clamping device.

The cowl unit may further be curved in the longitudinal direction of the subsea cable unit to prevent bending of the cable beyond a desired angle. Alternatively, the cowl unit may be substantially straight with more flexibility in one end such that after installation the cowl unit follows the subsea cable units catenary shape, so it is curved in the longitudinal direction.

The cowl unit may be provided with at least one motion arresting element on the side facing the subsea cable unit, where the at least one motion arresting element presses against the subsea cable unit.

The stabilizing device may comprise a first stabilization base and second stabilization base, each comprising at least one through-hole for a pile element which is adapted to fit in the at least one through-hole and to be driven into the seabed such that the first stabilization base and the second stabilization base can be securely anchored to the seabed.

The first stabilization base and the second stabilization base are preferably arranged on opposite sides of the subsea cable unit.

The first clamping device is preferably securely attached to the first stabilization base in one end and to the second stabilization base in the other end, and the second clamping device is preferably securely attached to the first stabilization base in one end and to the second stabilization base in the other end.

The first clamping device may comprise at least one dynamic absorber which is anchored to the first stabilization base and/or the second stabilization base in one end and to the cowl unit in the other end.

The first stabilization base and/or the second stabilization base are provided with a plurality of through-holes for pile elements which is adapted to fit in respective through-holes and to be driven into the seabed such that the first stabilization base and/or the second stabilization base can be securely anchored to the seabed by a plurality of pile elements.

The at least one through-hole is/are preferably provided with a guide element to facilitate the entering of the pile element during installation.

The pile element may be adapted for handling by an ROV.

The subsea cable unit may be provided with a cable protective device.

Preferably, the cable protective device surrounds the cable.

The cable protective device preferably extends at least through the stabilizing device. However, the stabilizing device may not extend through the entire stabilizing device in some instances.

The subsea structure is preferably securely mounted in or to the seabed.

There is also provided a subsea system comprising a subsea structure which is securely mounted in or to the seabed, and a subsea cable unit which extends between the seabed and a cable entrance on the subsea structure where the cable entrance is located above the seabed, wherein the subsea cable unit comprises a subsea cable with a cable protective system or a subsea cable only, and wherein the subsea system comprises a stabilizing device as defined above for stabilization of the subsea cable unit and comprising none, one, several or all of the additional features mentioned above.

The subsea system may be provided with a plurality of stabilizing devices arranged along the longitudinal direction of the subsea cable unit.

The stabilizing device may be arranged on a scour protection layer which is arranged on the seabed adjacent the subsea structure.

Alternatively, the stabilizing device may be arranged directly on the seabed.

The subsea structure may be a monopile of a wind power plant which is securely mounted to or in the seabed. The subsea structure may also be other subsea structures that are securely mounted to the seabed. Alternatively, the subsea structure may be a semi-submersible structure, for example a semi-submersible structure operating in fairly shallow depths, such as in depths up to 200-250 meters.

There is also provided a use of a stabilizing device as described above and/or a subsea system as described above, to stabilize a subsea power cable from an offshore wind power plant.

Thus, the stabilizing device according to the present invention provides a foundation for stable anchoring of a cable protection system and/or a cable to the seabed (fixed relative to the wind turbine generator or the substation foundation, with or without scour protection), with a specific and permanent bending strain relief, regardless of current or future seabed features or changes. The stabilizing device further provides an accountable bending strain relief, without knowing or risking seabed features or changes.

This allows the typical state of art seabed positioning tolerances (for the foundation, aperture heights, scour-protection, and cable & cable protection system) in installation to be intercepted and captured within the bending management system and stabilization.

Thus, the invention of the present application has at least the following advantages:
Stabilization of the cable protection system is carried out in scour-protection and/or seabed.
Bending strain is managed by built in bending strain relief.
Stabilization into seabed (through scour-protection or mobile seabed).
Bending strain relief and bending management are independent of the seabed features (the engineered bending management will remain, independent of the seabed features) and unaffected by seabed changes (mobility, scouring, sand-waves, seabed drop, etc.).
Stabilization is done without rock (or other ballasting material).
Stabilization is carried out while cable pull-in is performed.
The stabilizing device can be recovered (for cable change or other reason during operation, and at decommission).
Stabilization may be applied to existing (operative) cable protection system, facilitating the above-mentioned operative features (stabilization with a known bending management response).
Stabilization is performed by a remotely operated vehicle (ROV) with a tool-skid, no need for proximity vessel operation (very low impact risk to foundation and cable/cable protection system).
The weather window is not limited to platform access.

Furthermore, the stabilizing device according to the present invention further facilitates the following:
The stabilizing device allows for isolation of the dynamic forces from catenary part of cable protection system (curvature and tension in cable protection system is terminated at the stabilizing device), hence cable protecting requirement of the cable protection system from the stabilizing device to burial point is removed from most risks and fatiguing issues.
The invention reduces the dynamic forces that the catenary section of the cable protection system is exposed to.
The cable protection system is exposed to less curvature and be subject to lower stress.
The cable protection system is supported with a bending management system at touch-down, i.e., at the stabilizing device.
cable protection system tension from the catenary is contained into the stabilizing device, removing tension from the cable protection system on the seabed.
The curvature and tension stresses on the cable is reduced.
Cable fatigue life is increased.
The stabilizing device allows for a type-qualification with cable protection system (allowing a wide range of cable designs to meet the cable-fatigue-life requirement with a wide installation tolerance.
The stabilizing device allows use of a cable protection system flexible structure, which may be made of polyurethane, or any other suitable material other than polyurethane.
The stabilizing device allows for a cost-effective cable protection system design.

The stabilizing device may, for example, serve as a reliable seabed interface for fixed offshore wind foundations, but it is not restricted to this purpose. It can obviously be used with other types of installations in other offshore industries having fixed foundations. The stabilizing device may also be used in other areas where dynamics of metocean conditions can impact flexible lines (like cables, umbilicals etc.) in the seabed interface where the stabilization may be applied. These can be floating structures or other suitable offshore structures.

### Bending Strain Management/Bending Strain Relief

A purpose of the present invention has been, regardless of the nature of the seabed or changes therein, to provide the cable and cable protection system with a particular bend curvature, thus ensuring the cable and cable protection system design limits are not breached, and that the cable-fatigue-life is extended above required minimum.

The bending management system, comprising a cowl unit, will provide the cable and cable protection system with bending strain relief features (like a typical bend stiffener) even though this is covering a maximum of 180-degrees of the cable or cable protection systems circumference. The frequent dynamics of the seawater particles are, in a majority of the cases, directed to horizontal movements perpendicular to the direction of the cable and cable protection system.

Furthermore, the stabilizing device may provide the features to enclose tension and compression onto scour-protection or seabed in the cable and the cable protection system.

The stabilizing device may comprise both a bend stiffening structure and alternatives such as, for example, but not limited to, an apparatus resisting compression/elongation performing a two-dimensional bend-management, e.g., spring like or water hydraulic absorber type of apparatus.

Alternatively, a combination where the combined bending stiffness of the cowl unit may be provided by more than one feature, such as stiffness of the cowl unit and stiffness of the stays or absorber cylinders.

On the side of the stabilization base, or center of the stabilization bases if the stabilizing unit is provided with more than one, the bending strain management, i.e., the cowl unit, is positioned, and shaped with a half-cone to slide on top of the cable protection system. This half-cone or dome shaped structure is referred to as a cowl.

This provides a bending management system, which can be placed over the subsea cable unit. It can be positioned in proximity to the touch-down (where cable or cable protection system catenary touches the seabed or scour-protection) without need for absolute positioning at the touch-down.

The cowl unit has a tip which may be elevated above the wing structure to maintain a smooth curvature of the cable protection system and cable catenary.

The bending stiffness may be gradually increased from tip. This provides the cable and cable protection system with a seabed interface that manages bending, i.e., a bend stiffener towards a stabilized position. This relieves the cable and cable protection system for the bending strains managed by the stabilizing device.

The effect on the cable and the cable protection system is that the curvature is restricted to the bending moments allowed by the design of the stabilizing device. The removal of severe curvatures reduces global mobility and reduces local tension-slip-compression of the cable conductors. This reduces the wearing out of the cable, and significantly increases the cable-fatigue-life.

While the cowl is intended to be in contact with the 180-degrees upper circumference of the cable protection system and/or cable, the tip section may have a reinforced vertical wall to provide Z-axis stability if the cable protection system and/or cable catenary drops under the cowl arc. This allows for wide berth of tolerances relative to cable and cable protection system touch down, when placing the system on top of the cable protection system and the cable.

At the rear end “facing away from the wind turbine generator”, the stiffness of the structure is preferably very high, and may be solid, thus forming a progressively higher stiffness over entire length of the cowl.

The length of the bending strain management system provides a minimum limited curvature above the requirement for cable-fatigue-life (and larger than cable and cable protection system design limits). The stiffnesses and lengths of the cowl structure can be designed to provide sufficient low curvatures to ensure minimum cable-fatigue-life.

The bending stiffness of the cowl can preferably be supported from the absorber stag(s) from the base, thus increasing horizontal Z-axis stiffness and restricting vertical (Y-axis) movement.

The rear end of the cowl may, as mentioned above, end in a solid (nonflexible) section. Preferably, this end is kept fixed to the stabilization base or bases.

Alternatively, the stabilization base (in any shape) can be an enclosed structure with a flexible (elastic) front end interface. The bending management is provided with required stiffness (elastic) to obtain required curvature limits, the capacity of absorbing bending moments from either elastic interface, the cowl structure or in a combination.

Alternatively, the Bending Management system can be arranged as a gradual restriction in the cable protection system and/or cable free movement. This can be arranged as a half-cone trumpet shape, or preferably in a series of bars that as a function of their inner shape, or as a function of their structural stiffness, or any combination thereof. Preferably the arrangement can be made with a single or multiple rigid bars or similar arrangement to provide area for the tension strain management.

### Stabilization Base

The purpose of the stabilization base is to provide an interface between the bending and tension strain management systems and the foundation into the seabed.

The purpose of the stabilization base is also to provide a structure which when held towards the scour-protection and/or seabed, is positioned either above or buried into the materials below (scour-protection and/or seabed).

The apparatus consists of at least one solid stabilization base (an open frame or a block), which can be arranged on one side of the bending management system, or on both sides if there is more than one stabilization base.

The stabilization base preferably has vertical openings within its surface, or on the sides of the stabilization base, for at least one pile element.

Interfaces of the stabilization base for the at least one pile element may be arranged as substantially vertical holes, or reinforced openings within or on the outside of the base. Alternatively, a separate mechanical interface on the at least one pile, can provide the transfer of the foundation stability to the stabilization base.

The vertical holes or attachment points may be spaced to allow initial penetration on either side of large armor stones on a scour-protection top-layer.

There may be one or several slots on each stabilization base to provide variable positions for driving the at least one pile. Alternatively, the fixation may be with clamps or brackets (not fixed to the stabilization base) which are fitted to the piling type of foundation and arrests the stabilization base when the anchoring into the seabed is performed.

Alternatively, the stabilization base (in any shape) can be enclosed structure with a fixed rear end interface to the cowl unit, or the rigid part of the cowl unit integrated into to base. The stabilization base may be single sided or double sided, on each side of the bending management system (i.e., the cowl unit).

The stabilization base may be designed to have full capacity of anchoring with a single stabilization base but may offer options for one or more stabilization bases.

Preferably the stabilization base can be equipped with guiding means, for example, but not limited to, one or more pile element guides.

### Tension Strain Management/Friction or Mechanical Fixing

The purpose of the friction features is to arrest the subsea cable unit in the longitudinal direction. Dynamic forces are terminated in the friction section. This prevents the dynamic forces onto the catenary part of the trajectory transmitting tensions from impacting the cable or the cable protection system in the further routing.

The cowl unit may comprise several features to facilitate the following functions.

Towards the catenary and curved as an upward-arc with an elevated tip as mentioned above, the cowl unit may be provided with initial low bending stiffness, and towards the anchor plate an increasing bending stiffness.

At the rear end, away from the catenary part of the cable protection system and/or cable, the bending stiffness of the cowl unit increases until it gradually becomes rigid. In this rigid “rear end” of the cowl, the cowl arrests the subsea cable unit.

In the rigid friction section of the cowl unit, layers, pads, may provide a grip onto the cable or cable protection system. The forces are applied from the at least one pile element and the expansion device, pushing the cowl unit down onto the cable protection system surface.

Providing the cowl unit with a surface that corresponds to the external surface of the cable protection system and/or cable (e.g., but not limited to, providing an internal convex surface to follow a concave shape of the cable protection system and/or cable and/or protrusions to fit into grooves etc.), will provide mechanical arresting of the cable protection system inside the cowl unit. This will provide a solid anchoring of a cable protection system and/or cable inside the rigid part of the cowl.

For an operative stabilizing device (i.e., installed with cable protection system and cable system), the cowl unit will preferably have a section of high friction pads, which during the installation of the stabilization base(s) will be compressed onto the cable protection system surface. Using a compression plate will allow for variations in the cable protection system, marine biofouling, and sediments.

If the cable protection system or the cable has a variable diameter external, the cowl unit may be made to mirror this external shape, and thus preventing longitudinal movements of the cable protection system when tensioned.

For a purpose-built cable protection system, the location fix may be served with a cam and set of grooves.

The rigid section of the cowl may have friction pads or structures on inside to provide sufficient friction on top 180-degrees of cable protection system to arrest the cable protection system.

A proprietary cable protection system interface with grooved section may interface with interfacing structure on the inside of the cowl unit (for example a cam protruding into any groove will arrest the cable protection system and prevent longitudinal movements of the cable protection system when tensioned).

### Foundation

The purpose of the foundation is to provide a fixed horizontal position relative to the subsea structure, such as the wind turbine generator or substation foundation, regardless of surface seabed mobility or changes.

The preferred method of foundation is to use at least one pile element or ground screws or similar. The at least one pile element may be facilitating that a remotely operated vehicle is carrying both base/bend management system and the foundation (piles, screws, etc.) in a tool skid, powered from the ROV. The tool skid may carry/dock the stabilization base/cowl unit and required pile elements, screws, or anchors for one cable end.

Preferably, the operation is undertaken remotely, such as up-ending and penetration driving means, and preferably by vibro-piling, torque-screw, suction anchor piling.

The at least one pile element can be a typical pile (e.g., of steel or concrete or any other material with capacity to be driven through scour-protection and/or seabed), ground screws (pile shapes structures that by rotation penetrates seabed), or it can be types of suction pile anchors.

Preferably each pile element, screw, or other foundation has the capacity to hold the stabilization base fixed to the seabed until the end of life of the project. This includes (but is not limited to) absorbing installation impacts, combined operational and compression vertical and horizontal forces.

During installation of the at least one pile element, hammering, vibrating, screwing, suction, or any combination can be used.

The at least one pile element may be a H-beam or an X-beam, a sheet piling, a wooden pile, a pipe, etc. (hammered or vibrated) in any shape or profile. For example, the at least one pile element may be a ground screws or a suction pile or a cone. The at least one pile may also be anchored in solid rocks.

The at least one pile element may be equipped with an expansion device, for example an expandable (compressible) coupling. The compression can be achieved by the force of the at least one pile while it is driven into the seabed.

Preferably the expansion device is compressed and fitted to the pile etc. prior to being installed. The arrangement retaining the compression can be arranged to degrade or release in short time after installation, releasing the compression force onto the base.

### Alternative Foundation

There is further provided an alternative foundation device for a subsea cable unit, which comprises a cable (or a cable provided with a cable protection system) to mitigate the dropping of the seabed without changing the catenary shape of the subsea cable unit that is installed. Such dropping of the seabed may arise from erosion or scouring of the seabed locally below the subsea cable unit or globally in the area around the subsea cable unit.

This alternative foundation device therefore has the advantage of enabling installation of the subsea cable unit in positions where erosion has created a free-span of the subsea cable unit between the touch-down point of the subsea cable unit as built and the original pre-erosion seabed level or scour-layer level. Thus, the alternative foundation device enables the subsea cable unit to be installed as it is suspended above the seabed level, providing an artificial touch-down base for cable and CPS elevated above the seabed level without changing the catenary shape and therefor the tension in the cable.

The foundation device may also be used in cases where it is expected that erosion will occur due to local water current conditions or when laying a subsea cable unit across depression in the seabed that would cause too large bending of the subsea cable unit.

Thus, there is provided a foundation device for a subsea cable unit, the subsea cable unit comprising a subsea cable that is provided with a cable protective system or a subsea cable only, the foundation device comprising:
a pile element that is adapted to be driven into the seabed or scour protection layer,
an attachment unit which is mounted to an upper portion of the pile element,
a support element which is attached to the attachment unit and is adapted to support the subsea cable unit when the foundation device is installed,
a locking element which is attached to the attachment unit and adapted to lock at least the subsea cable unit to the foundation unit.

Preferably, there is further provided a bend stiffener unit comprising a bend stiffener body which is adapted to be arranged on the subsea cable unit in order to control bending of the subsea cable unit, the bend stiffener unit further comprising at least one attachment element which is attached to the bend stiffener body and extends outwards from an outer surface of the bend stiffener body, where the attachment element is adapted to be positioned between the support element and the locking element.

The bend stiffener unit is preferably provided with at least two attachment elements arranged on one side of the bend stiffener body and spaced apart in a longitudinal of the bend stiffener body. Preferably, the distance between the two attachment elements is adapted to the size or shape of the locking element.

The support element and/or the locking element are preferably adjustably mounted on the attachment unit.

The attachment unit may be threaded and the support element or the locking element may be correspondingly threaded such that the position of the support element or the locking element on the attachment unit is adjustable.

The support element may be provided with a cone-shaped support element contact surface on which the subsea cable unit rests. The conical shape of the support element is preferably adapted to provide the best possible support to the subsea cable unit in view of the inclined position of the pile element relative to the seabed or the scour protection layer after installation.

The bend stiffener body of the bend stiffener unit preferably has a half-dome shape. That means that the bend stiffener body covers approximately the upper half of the outer surface of the subsea cable unit when the bend stiffener unit is arranged on the subsea cable unit.

The bend stiffener unit is preferably provided with attachment elements which are wedge-shaped with respective attachment element contact surfaces that are adapted to abut the locking element.

The locking element is preferably provided with a locking element locking surface that faces the attachment element or attachment elements of the bend stiffener unit which is conically shaped.

Preferably, the locking element locking surface abuts the attachment element contact surface of the attachment elements of the bend stiffener unit after installation of the foundation device.

The bend stiffener unit is further preferably provided with four attachment elements where two attachment elements are arranged on either side of the bend stiffener body and spaced apart in a longitudinal of the bend stiffener body.

Preferably, the distance between the two pairs of attachment elements on either side of the bend stiffener body is adapted to the size of the locking elements, i.e., the conical shape of the locking elements which are arranged or mounted on the attachment unit of the two pile elements.

There is also provided a method for providing a foundation for a subsea cable unit, where the subsea cable unit comprises a subsea cable that is provided with a cable protective system or a subsea cable only, the method comprising the following steps:
providing two foundation devices according to any one of the embodiments described above,
arranging the pile elements of the foundation devices partly in the seabed and/or scour protection layer such that they are inclined relative to the seabed or the scour protection layer, and such that the support elements arranged on the attachment units are in a position to support the subsea cable unit,
if the subsea cable unit has not been installed, install the subsea cable unit such that it is supported by the support elements of the foundation devices,
arranging the locking elements on the attachment units of their respective pile elements such that the subsea cable unit is locked in its position on the support elements.

The method further comprises arranging a bend stiffener unit on the subsea cable unit such that the attachment elements are adjacent the attachment unit of the pile elements, before arranging the locking elements on the attachment units.

The locking elements are preferably arranged on the attachment units of their respective pile elements such that the locking elements abuts the attachment elements of the bend stiffener unit and locks the bend stiffener unit and the subsea cable unit in their positions.

The two pile elements are preferably arranged so that the support elements support the subsea cable unit after installation. The position of the support elements on the attachments may be adjusted to a desired position so that they support the subsea cable unit.

After the two pile elements are arranged in their desired positions and the support elements support the subsea cable, the bend stiffener body is preferably arranged on top of the subsea cable unit such that the attachment elements of the bend stiffener unit are adjacent the attachment unit on the pile elements.

The pile elements are arranged such that they are inclined relative to the seabed or the scour protection layer. The pile elements thereby have a scissor-shaped form. This arrangement of the two foundation devices will provide a stable support for the subsea cable unit.

### Compression Onto Seabed

The purpose of this feature is to maintain vertical seabed contact of the base and bending management system in case the level of the scour-protection or seabed drops.

Compression of the stabilizing device onto the underlaying seabed or scour-protection is required to ensure the cable protection system is retained within the cowl. To support potential scour-protection sinkage or mobile seabed lowering and scouring, the vertical foundation of the base is coupled to the at least one pile element, rod, pillar etc., via a pre-tensioned expansion device. This expansion device forces the stabilization base down towards the seabed or the scour-protection, hence securing that the stabilization base will stay at seabed level or scour-protection level after eventual drop in the level of the seabed or the scour-protection. The expansion device may comprise a compression spring arrangement, such as a spring element, or any other apparatus able of expanding in length while at the same time forcing the stabilization base down towards the seabed or the scour-protection. The expansion length is preferably designed to at least the potential maximum drop in the level of the seabed or the scour-protection.

The expansion device may be pre-tensioned and compacted by a degradable clip, rope or similar, which will release after a pre-determined period after installation.

### Allowance for Wind Turbine Generator Foundation Drop (Sinking Into Seabed)

The purpose of this feature is to maintain the cable protection system and cable curvature without compressions in case the foundation of the wind turbine generator sinks into the seabed after cable installation.

By pre-arranging the curvature of the cable protection system, by positioning the base on catenary inside of the cable protection system touch down, reductions in aperture heights can be absorbed while maintaining large bending radii, and at the same time ensure cable route distance inside the cable protection system and MP foundation is not reduced. This will prevent compression of the cable design inside (which increases cable fatigue).

### Installation Features

The purpose of these features is to facilitate minimal impact on critical paths of the offshore construction campaign, risk mitigation and provide stabilization to installed cable & cable protection system at once.

The stabilizing device is designed to be dropped on top of the cable or cable protection system, so a cable or cable protection system laying on top of underlaying seabed is covered by the structure. The versability of underground seabed anchoring allows one to choose to use a single pile element or a plurality of pile elements to make the stabilization base a stable foundation.

Both the stabilizing device and the pile elements can be delivered by a Remotely Operated Vehicle (ROV), with tool skid capable of docking the stabilizing device and pile element(s) prior to launching the ROV. At the underwater location the stabilizing device is released and placed on top of the cable protection system, for example with a manipulator arm, and the tool skid performs upending of the at least one pile element, and when the bottom end is within the interface of the stabilization base, driving the pile from the power unit of the ROV, for example a Hydraulic Power Unit for hydraulic driven ROVs, or Electric power packs.

The installation eliminates needs for heavy lifting or proximity of the surface vessel to the offshore subsea structure.

Furthermore, stabilization can be performed simultaneously with cable-pull-in, integrated into the pull-in-procedures, without compromising critical path. It can, for example, be performed within time slots between when the cable protection system is locked into the aperture or bell-mouth and establishing the temporary cable hang-off. Typically, a slot of 30-60 minutes where the ROV is monitoring the seabed interface is sufficient, thus utilizing the slot for the foundation installation does not affect cable-lay efficiency. This means that the stabilization of the cable protection system and/or the cable can be provided within the cable pull-in sequence, and it can be achieved by utilizing the idle observatory ROV during the typical 30-60 minutes wait between cable protection system latching/interlocking and temporary cable-hang-off in tower. In this fashion the stabilizing device is out of the critical path of the cable installation, does not delay the cable installation and provide immediate stabilization at pull-in.

The installation does not affect the cable inside the cable protection system, for example the stabilization can be performed after cable protection system lock-in, allowing the cable to be pulled to switchgear also after stabilization.

The installation can also be performed from CLV (Cable Lay Vessel) operated by an ROV.

### Materials

Cost is a key obstacle to offshore wind. The present invention allows for the use of “lower grade” industrial available materials, such as glass-fiber-reinforced-epoxy, carbon steel etc. and can provide the use steel with anodes, and a design to allow water absorption to meet design criterion's, including end-of-life. Therefore, use of exotic materials, such as high-cost steels, composites, or polymers, can be avoided.

Using general industrial type materials, not specialized for cable protection or other niche market, not only a low cost of materials will be ensured, but also industrial production in most regions is allowed, preventing shipping costs, CO2emissions and opening local supply chain opportunities in the same region as the wind park is installed.

### Type-Qualification

The invention facilitates optional type-qualification (within a wide tolerances of foundation interface height, catenary lengths and positions of the invention) for a wide range of cable designs. Such type-qualification is possible because the stabilization with a designated bending response removes the task of handling curvature and stress at the touch-down of catenary from the cable protection system. This allows to engineer capacity for worst case scenarios into the invention, reducing bending moments and tensions applied to and managed by the cable protection system. The capacity can be designed to ensure that the most demanding cable design will meet the cable-fatigue-life requirements.

This warrants that the cable boundary conditions, considered in the cable design phases, can be optimized. Without need to consider extreme curvature and tension parameters for the cable design, cable design parameters that serves the cables primary functions (the transport of electric energy and signals) and costs involved can be optimized. There are several advantages achieved with the stabilizing device with regard to the installation, including that there is no proximity of foundation vessel operation, there is also no heavy lifting of ballasting materials, there is immediate stabilization (embedded in cable installation campaign), that the operation is swift (complete in 15-25 minutes), and that the operation can be performed on the seabed or through scour-protection.

Installation of the stabilization to operative cable protection system and cable systems can be performed from any support vessel with ROV handling capabilities, which means that there is similarly no proximity of foundation vessel operation, no heavy lifting of ballasting materials, no personnel required in the tower, and the operation is swift (complete in 15-25 minutes).

Thus, the present invention provides numerous advantages. First, it provides stabilization of the cable protection system and/or cable, removing risks of seabed features or seabed changes. The cable protection system and/or cable is stabilized removing impacts seabed features, risks and uncertainties including, but not limited to, seabed mobility and variation.

It also provides stabilization with a bending management system to remove risks that cable-fatigue-life is compromised (removing risk of cable failures in operational life). A bend management system is provided which relieves cable protection system and/or cable from severe curvature, reducing local tension-slip-compression impact on cables, increasing cable-fatigue-life.

Furthermore, it provides stabilization embedded in cable installation campaign. Stabilizing device enables imminent stabilization embedded in cable installation campaign without impacting critical path.

It provides stabilization without use of ballast materials (rock, rock-filter-bags, matrasses, etc.). The stabilizing device works without need for ballast materials. It provides stabilization with no craneage/lifting operation, eliminating needs for costly lifting or crane operation.

It provides stabilization with no proximity to wind turbine generators or Substations, meaning surface vessel operations in proximity of offshore foundations is not needed. This provides a wide berth of tolerance for positioning, meaningtedious (and often impossible) position accuracy demands are eliminated.

Additionally, it captures MP foundation drop after installation. This means that cable protection system and/or cable compressions, allowing sinkage (drop) of the monopile of the wind turbine generator, is eliminated.

In short, the system provides a solution to solve cable protection system and/or cable-fatigue-life threatening conditions, removing the uncertainties of the seabed interface, and removing the need for ballasting materials, thereby offering a stabilized bending management system absorbing seabed changes and installation variations.

Not only is the need for ballasting materials, transportation and installation eliminated, but also risks and uncertainties to the cable and/or cable protection system, of stabilization with ballast materials are removed.

### DESCRIPTION OF THE DRAWINGS

A non-limiting embodiment of the present invention will now be described with reference to the attached figures, where:

FIG. 1 illustrates the stabilizing device and the subsea system from the side.

FIG. 2 illustrates the stabilizing device and the subsea system seen in a perspective view.

FIG. 3 illustrates the stabilizing device.

FIG. 4 illustrates the stabilizing device with the pile elements and their expansion devices.

FIG. 5 illustrates the stabilizing device and the pile elements driven into the seabed and/or the scour protection layer.

FIG. 6 illustrates the cowl unit of the stabilizing device with the first and second clamping devices.

FIG. 7 illustrates the stabilizing device without the pile elements.

FIG. 8 illustrates the stabilizing device shown in FIG. 7 seen from the front.

FIG. 9 illustrates the stabilizing device including two stabilization bases, a first stabilization a base and a second stabilization device arranged on either side of the cowl unit.

FIG. 10 illustrates the stabilizing device including a separate, loose clamping element comprising at least one hole for a pile element.

FIG. 11 illustrates the stabilizing device seen from below with the separate, loose clamping element as shown in FIG. 10.

FIG. 12 illustrates the stabilizing device including with a separate, loose clamping element with a different design, also comprising at least one hole for a pile element.

FIG. 13 illustrates the stabilizing device including a dynamic absorber.

FIG. 14 illustrates the stabilizing device including two dynamic absorbers attached to the cowl unit and to the first stabilization base and the second stabilization base respectively.

FIG. 15 illustrates the cowl unit being provided with motion arresting elements adapted to engage with the subsea cable, or the cable protection system if the subsea cable is provided with a cable protection system, passing through the cowl unit of the stabilizing unit.

FIG. 16 illustrates the cowl unit being provided with motion arresting elements shown in FIG. 15 seen from a slightly different angle.

FIG. 17 illustrates the cowl unit being provided with a motion arresting element in the form of slot/cavity/groove/recess which is adapted to engage with a section of the cable protection system and/or cable passing through the cowl unit.

FIG. 18 illustrates the stabilizing device positioned cantered on top of the cable protection system and/or cable touchdown.

FIG. 19 illustrates the stabilizing device positioned outside the touch-down-point of the cable protection system and/or the cable system.

FIG. 20 illustrates two positions of the stabilizing device center, positioned outside the touch-down-point of the cable protection system and/or the cable system on the left in the figure and inside the touch-down-point of the cable protection system and/or cable system to the right on the figure.

FIG. 21 illustrates the stabilization device arranged on the scour protection.

FIG. 22 illustrates a stabilization base where the holes for the pile elements are provided with respective guide elements.

FIG. 23 illustrates the expansion device of the stabilizing device in a compressed state in the middle in the figure and a relaxed state to the right in the figure.

FIG. 24 illustrates the stabilizing device arranged on the scoured seabed.

FIG. 25 illustrates the stabilizing device in two positions in the case of a drop of the level of the seabed where its installation height on what were the seabed level at time of installation is shown on the top in the figure, and after the drop of the seabed is shown at the bottom in the figure.

FIG. 26 illustrates the stabilizing device at the time of installation before any drop in the level of the seabed.

FIG. 27 illustrates the stabilizing device after a drop in the level of the seabed.

FIG. 28 illustrates a bending management system that can be used as an alternative to the cowl unit shown in FIGS. 1-26.

FIG. 29 illustrates the bending management system shown in FIG. 28 seen from the side.

FIG. 30 illustrates the stabilizing system with a number of clamping devices that form a shape of a half-trumpet, i.e., with gradually larger lengths from one end to the other.

FIG. 31 illustrates the stabilizing system with a number of clamping devices shown in FIG. 30 seen from above.

FIG. 32 illustrates an arresting device that positively deform the outer surface of the cable protection system to reinforce longitudinal arresting.

FIG. 33 illustrates the stabilizing device shown in FIG. 32 seen from below.

FIG. 34 illustrate a subsea cable provided with a cable protection system arranged on the seabed or on a scour protection layer on the seabed.

FIG. 35 illustrates the cable with the cable protection system shown in FIG. 34 where the seabed or the scour protection layer has dropped a distance D, for example due to erosion, so that the cable and cable protection system is suspended above the seabed or the scour protection layer.

FIG. 36 illustrates the subsea cable unit and two foundation devices arranged in the seabed and/or the scour protection layer, inclined relative to the seabed or scour protection layer and forming a scissor-shape, and supporting the subsea cable unit which is suspended above the seabed or the scour protection layer.

FIG. 37 illustrates the subsea cable unit being supported by the two support elements arranged on the two pile elements of the foundation devices, and the bend stiffener unit being lower onto the top of the subsea cable unit.

FIG. 38 illustrates the same process as in FIG. 37, i.e., the bend stiffener unit being lower onto the top of the subsea cable unit, seen in a side view.

FIG. 39 illustrates the subsea cable unit with the bend stiffener unit installed on top of the subsea cable unit and lock in their positions by locking elements which are arranged on the pile elements.

FIGS. 40a and 40b illustrate the same as FIG. 39 seen in a front view and a side view respectively.

### DETAILED DESCRIPTION

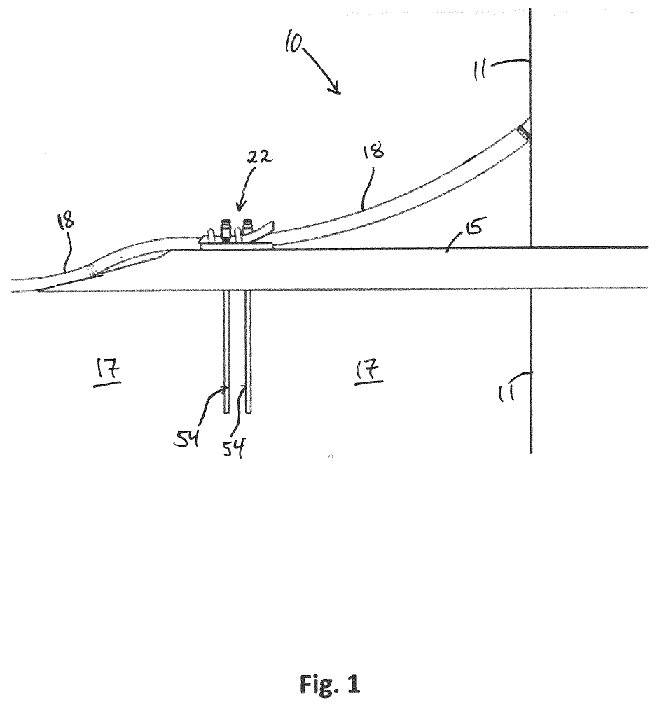

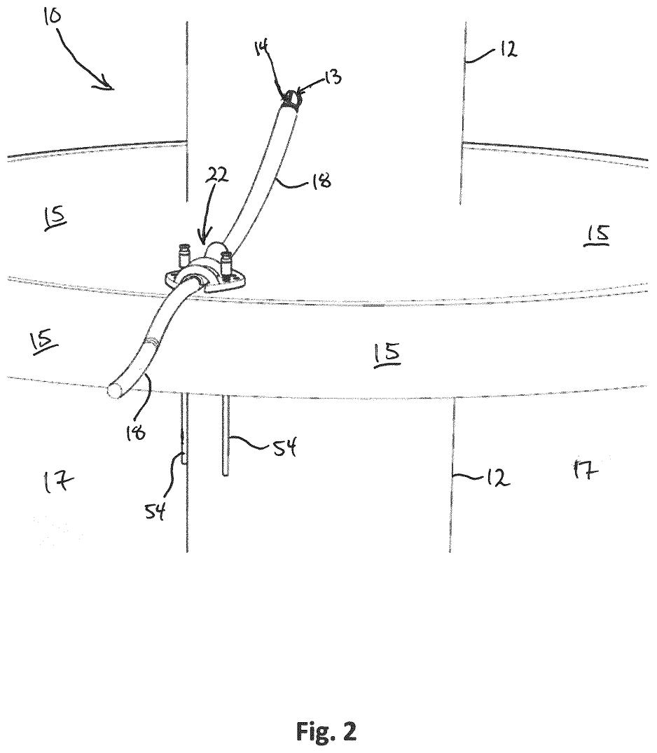

Firstly, it should be noted that the subsea cable unit 18 of the present invention may be a cable only or a cable provided with a cable protection system 20. In FIG. 1 and FIG. 2 a stabilizing device 22 and a subsea system 10 according to the present invention is shown where the subsea system comprises a monopile 12. One particular use of a stabilizing device 22 according to the present invention, is in the offshore wind industry where a known cable protection system 20 for a monopile foundation 12 without J-tube arrangements-which is referred to as “J-tube-less”. Here an cable entrance or aperture hole 13 in the monopile 12, where the cable protection system 20 of the subsea cable unit 18 is mechanically locked into the aperture hole 13 with the mechanical connector/latch/interface-unit 14 of the cable protection system 20.

The stabilizing device 22 is founded into the seabed 17 with one or more pile elements 54, which penetrates through upper, and mobility affected top layers and possible scour-protection layers 15.

While the stabilizing device 22 is shown for a subsea cable unit for a monopile foundation 12, it serves the same basis with other types of foundations and interfaces. This is, e.g., but not limited to, J-tube bellmouth interfaces for wind turbine generators and can be applied to other seabed interfaces where underwater lines (cables, flexibles, umbilicals, etc.) will benefit from a controlled bending management system.

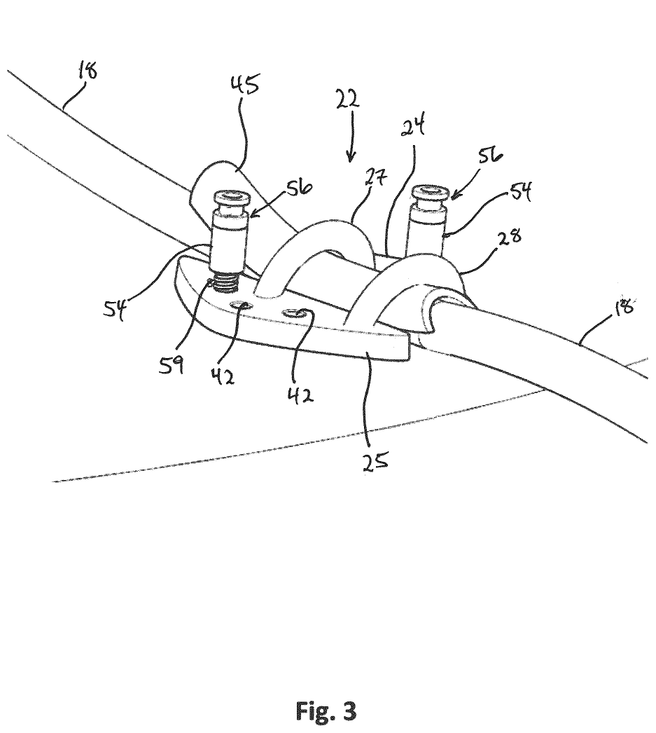

A stabilizing device 22 according to the present invention is shown in more detail in FIG. 3. The stabilizing device 22 is preferably designed to fit on top of the subsea cable unit 18, to be placed on top of the cable protection system 20. Preferably the stabilizing device 22 is fixed to its position relative to the wind turbine generator or substation foundation, with pile elements 54, where the top portion 56 of the pile elements 54 have a handling interface 57 (see FIG. 23) for handling and up-ending, for example by an ROV. The one or more pile elements 54 provides the horizontal stability for the stabilizing device 22. The pile elements 54 also provide the vertical stability of the stabilizing device 22 towards the seabed 17 and/or scour-protection layer 15. Preferably the top portion 56 of the pile elements 54 of the stabilizing device 22 can be equipped with an expansion device 59 which is provided with an expanding capacity. This provides a vertical force onto at least one stabilization base 24, 25, which the stabilizing device 22 is provided with, ensuring that the stabilizing device 22 remains compressed towards the seabed 17, also in a situation where the level of the seabed 17 drops due to for example erosion.

The stabilizing device 22 provides the subsea cable unit 18 with a bending strain relief functionality, which is preferably arranged as a cowl unit 45 which is a dome shaped structure. The cowl unit 45 covers up to 180-degrees of the upper circumference and preferably over 180-degrees of the upper circumference of the subsea cable unit 18. To serve a bending management system, the cowl unit 45 may be assisted with a flexible interface, preferably in the form of a first clamping device 27 attached to the at least one stabilization base 24, 25 towards to subsea cable unit 18 and/or a cable catenary, and a more rigid interface, preferably in the form of a second clamping device 28, which is provided with a higher bending moment than the first clamping device 27, toward the other end of the at least one stabilization base 24, 25 (i.e., the end away from the subsea cable unit catenary).

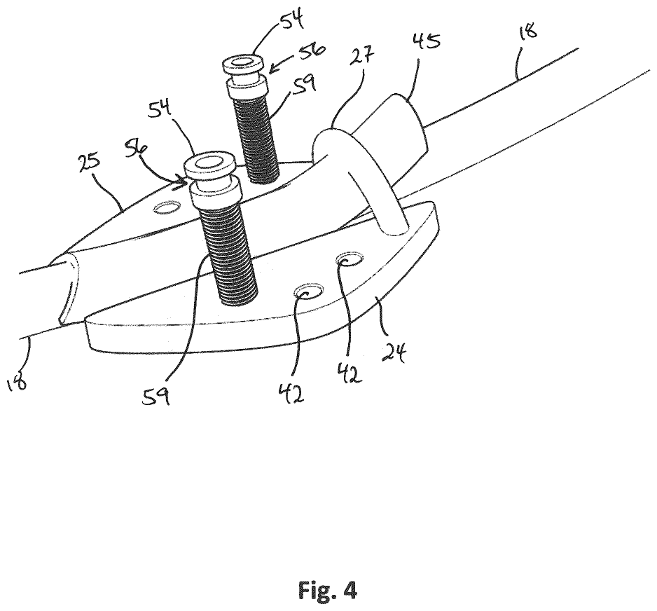

As illustrated in FIG. 4, the stabilizing device 22 can be arranged on top of the subsea cable unit 18, i.e., the cable protection system 20 and/or cable, with its at least one stabilization base 24, 25 arranged on one, or as shown in FIG. 4, both sides of the subsea cable unit 18. A dual side stabilization base 24, 25, i.e., comprising a first stabilization base 24 and a second stabilization base 25 which are arranged on either side of the subsea cable unit 18 passing through the stabilizing device 22, may be adapted for increased stability on top of an uneven surface (e.g., but not limited to large size armor layer rocks, e.g., but not limited to D90 rocks (which are 900 mm in diameter)). The first and second stabilization bases 24, 25 are provided with at least one attachment device, for example a through-hole 42, for the pile elements 54. In FIG. 4, the first and second stabilization bases 24, 25 are shown provided with three through-holes 42 each, through which a pile element 54 may be passed. Each of the first and second stabilization bases 24, 25 are stabilized in this example with a single pile element 54 although there may be provided a pile element 54 in each through-hole 42. The top portion 56 of the pile elements 54 have sufficient lengths to be provided with an expansion device 59 as shown in the figure, which can be compressed during the driving of the pile elements 54, or preferably as shown with expansion devices 59 with prearranged compressed lengths before installation of the stabilization device 22.

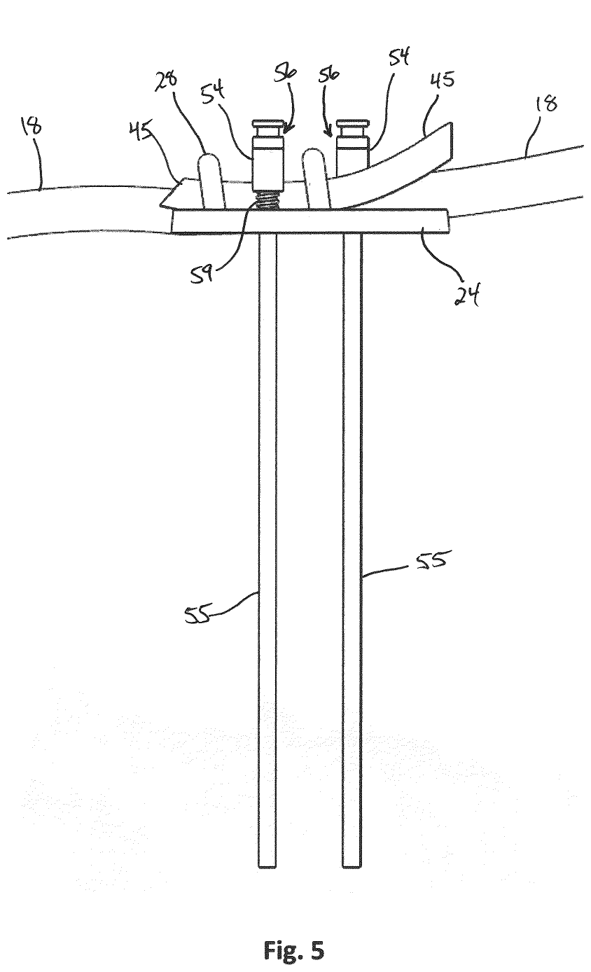

As illustrated in FIG. 5, the stabilizing device 22 may be positioned onto the seabed with no scour-protection layer 15 and the pile elements 54 will penetrate into the seabed 17. The penetrated length 55 of the pile elements 54 will sustain both horizontal position relative to the monopile 12 of the wind turbine generator or the substation foundation, and with the expansion device 59, clamping the vertical position of the at least one stabilization base 24, 25 and hence the cowl unit 45 and the first and second clamping devices 27, 28—onto the subsea cable unit 18.

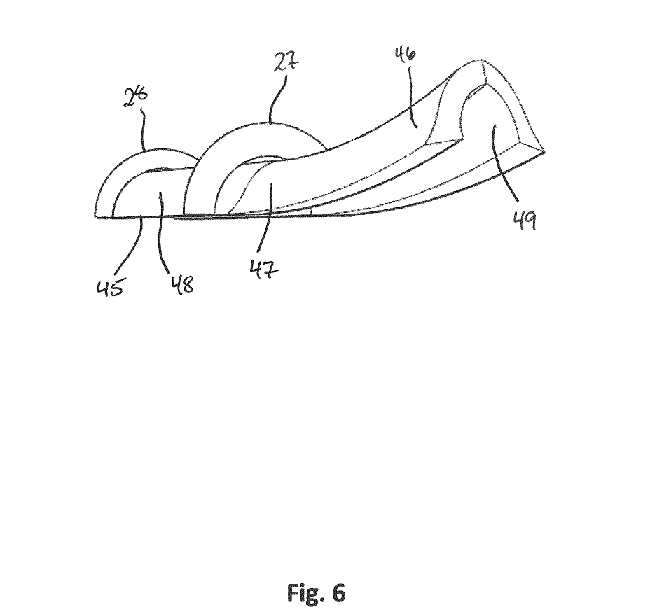

As illustrated in FIG. 6, the cowl unit 45 of the bending management system may be arranged in a domed shape and in the longitudinal direction of the cowl unit 45, preferably with a flexible tip 46 which allows the domed shape of the cowl unit 45 to follow the trajectory of the subsea cable unit 18 catenary. With a relatively soft tip such that when the dome center 47 of the cowl unit 45 and a horizontal part 48 of the cowl unit 45 is pressed down around the subsea cable unit 18, the tip 46 of the cowl unit 45, having a low stiffness, will a) follow the catenary shape of the subsea cable unit 18, and b) ensure a tapered bending strain relief with lowest enforcement at the start of the dome. The side parts 49 of the dome may be curtained down, to allow guide of the subsea cable unit 18, even if this is not compressed towards the inner roof of the dome of the cowl unit 45.

The stiffness of the cowl unit 45 of the bending management system is arranged similar to a conventional bending strain relief, with a soft(er) tip 46, and over the length of the domed cowl unit 45 the stiffness is increased. At the opposite end, facing away from the soft raised tip 46, the bending strain relief preferably is terminated into a rigid end section. This rigid end may be an integral section of the at least one stabilization base 24, 25 (not shown on FIG. 6), or connected by a rigid support frame, in the form of the second clamping device 28, to the at least one stabilization base 24, 25 as shown in FIG. 6.

This set up is like a rigid termination of a conventional bending strain relief/end stiffener. Where the base is a rigid metallic flange arrangement, and the stiffness of the bending strain relief/end stiffener is engineered to provide the flexible, such as a flexible flowline, umbilical, cable or line, with a pre-determined curvature depending on the force and angle that the flexible is pulled from (typically presented in a polar diagram). To provide the flexible flowline, umbilical, cable or line with a sufficiently long fatigue-life, its design-limits and fatiguing curvature and tension pairs must be served by the bending management system.

This can be arranged by the domed cowl unit 45 which in itself holds the sufficiently increased stiffness over its length, or the domed section may be assisted by flexible support or dampening devices between the tip and rigid end, shown as the dome center 47 in FIG. 6, so that the total management system provides sufficient low curvature of the flexible flowline, umbilical, cable or line to provide sufficient fatigue life.

The nature of the stabilization device 22 allows free movements in the upper 180-degrees only. The seabed 17 (or scour-protection 15) and the trajectory of the subsea cable unit 22 from the foundation interface will restrict movement of the subsea cable unit to side way (omnidirectional) and upwards (lift). Hence, the domed cowl unit 45 must manage dynamic movements of the subsea cable unit 18 in these directions only.

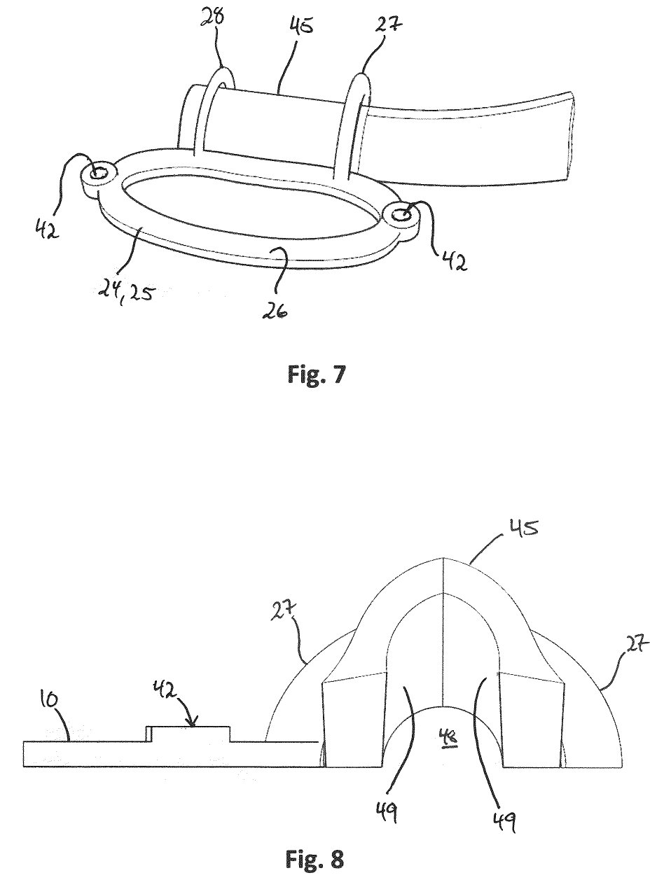

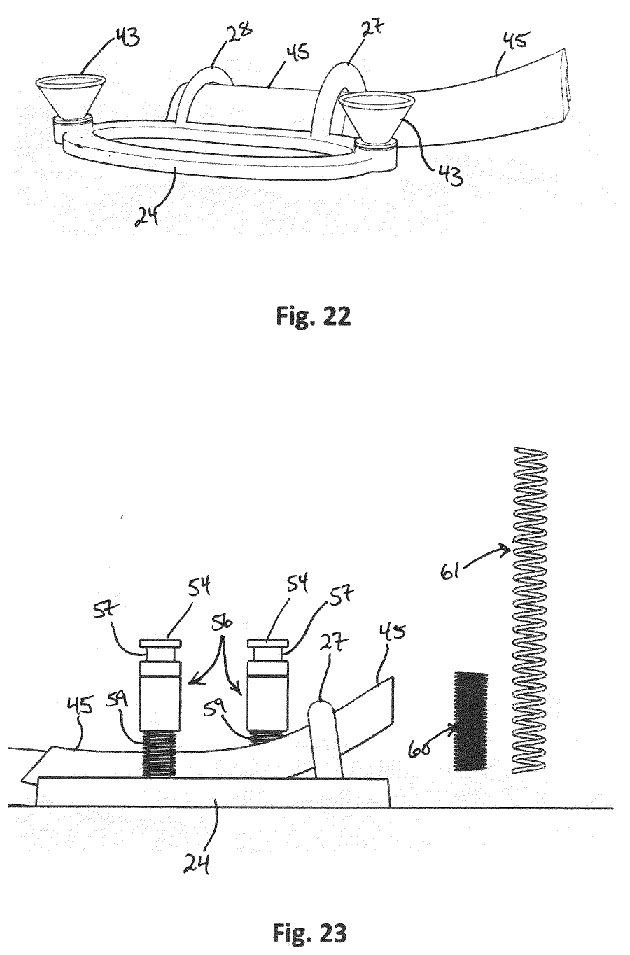

FIGS. 7 and 8 illustrate a stabilization plane 26 of the at least one stabilization base 24, 25 arranged with integrated through-holes 42 for pile elements 54 in an open structure. The through-holes 42 may be provided with one or more guide elements 43 (not shown in FIGS. 6 and 7, but see FIG. 22) to facilitate the insertion of the pile elements 54 into the holes.

The horizontal part 48 of the domed cowl unit 45 is designed to arrest the subsea cable unit 18 towards the seabed 17 (or scour protection 15) as will be further explained below.

Alternatively, the at least one stabilization base 24, 25 may be provided on one side of the cowl unit 45 only, while the number of through-holes 42 for pile element 54 can be one or more as explained above.

Alternatively, a stabilization base 24, 25 may be arranged on both sides of the cowl unit 45. Again, the number of through-holes 42 for pile elements 54 in each stabilization base 24, 25 can be one or more.

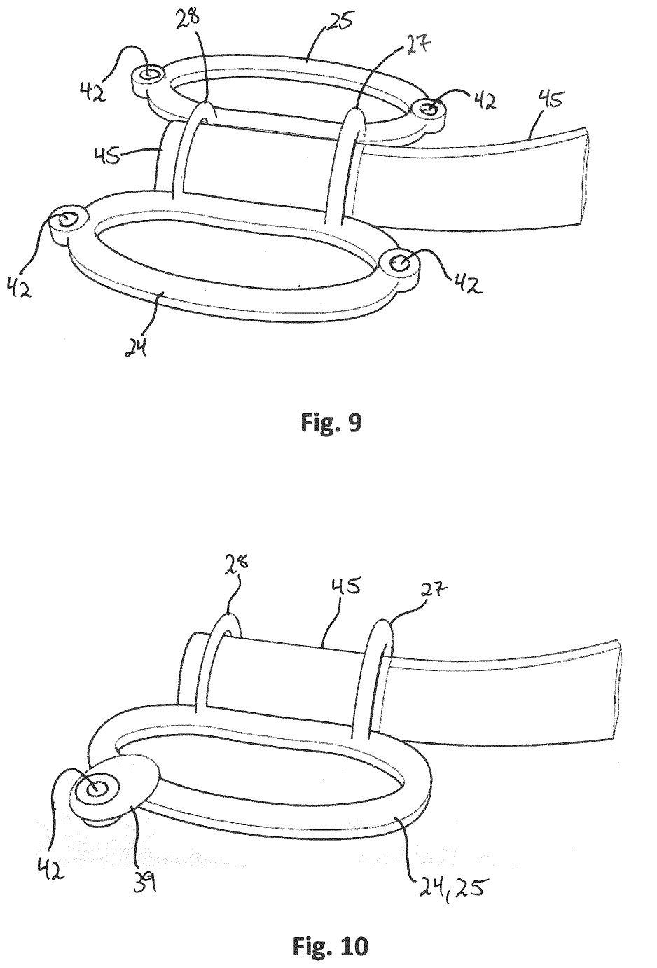

In another alternatively, as shown in FIG. 9, two stabilization bases 24, 25 may be provided on both sides of the cowl unit 45.

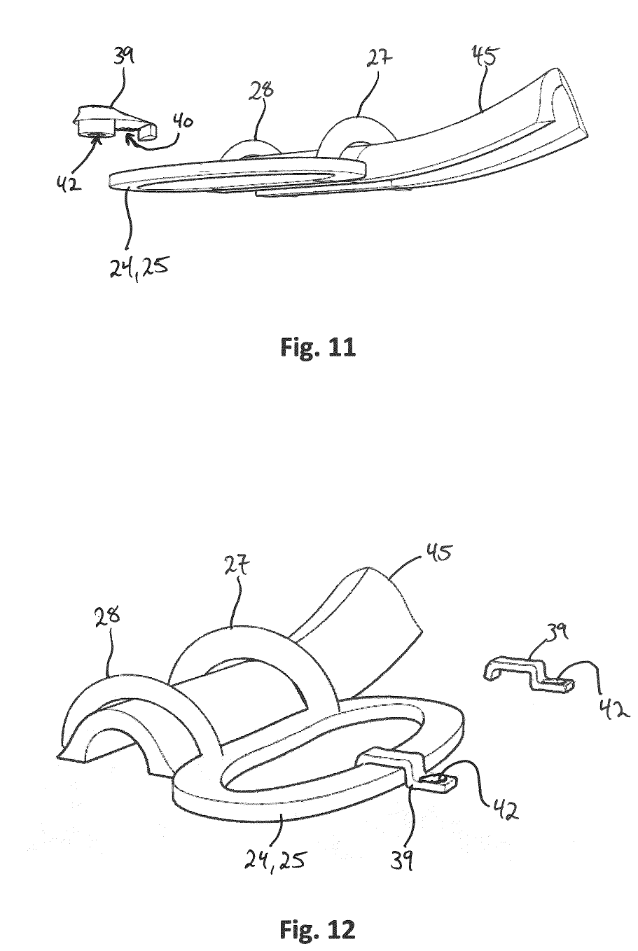

As shown in FIGS. 10-11, the stabilization base 24, 25 may be designed without designated through-holes 42 for pile elements 54. Instead, one or more loose clamp elements 39 can be used, each comprising at least one through-hole 42 for a pile element 54.

The clamp element 39 is provided with a groove 40 to arrest the open, at least one stabilization base 24, 25 as, or a combination where a grove 40 or slot in the at least one stabilization base 24, 25 can form an interface for a tap on the clamp element 39 (or reverse, a protrusion of the at least one stabilization base 24, 25 can fit into the groove 40, a recess or a slot of the clamp element 39).

Alternatively, as illustrated in FIG. 12, the at least one stabilization base 24, 25 can be arrested by a clamp element 39 in the form of a clip comprising at least one through-hole 42 for a pile element 54.

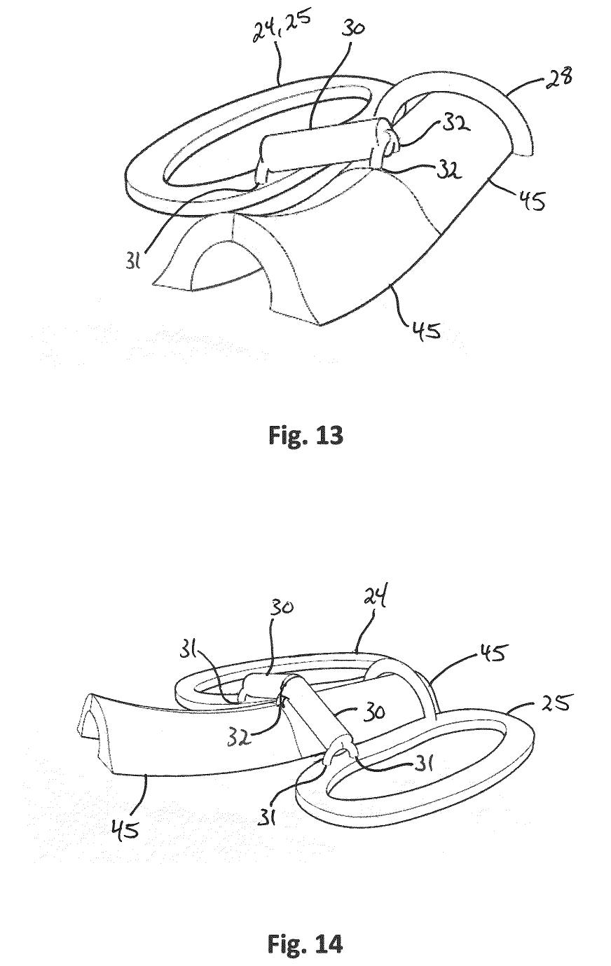

As illustrated in FIGS. 13 and 14, the cowl unit 45 of the bending management system can, alternatively to the flexible first clamping device 27, be supported by dual absorber devices 30 as shown in FIG. 14 or a single absorber device 30 as shown in FIG. 13, depending on whether the stabilizing device 22 is provided with respectively two or one stabilization base 24, 25, to derive at the preferred curvatures. The absorber devices 30 can in one end be anchored onto a first anchor section 31 on the single stabilization base 24, 25 as shown in FIG. 13 or both stabilization bases 24, 25 as shown in FIG. 14, and anchored to a second anchor section 24 on the cowl unit 45 in the other end.

For the bending management system to replicate a bending strain relief/end stiffener, where traditionally the flexible is mechanically terminated onto fixture, rigid to the termination of the bending strain relief/end stiffener-the stabilizing device 22 is preferably adapted to arrest the subsea cable unit 18 in its longitudinal direction. This to ensure that the dynamic movement on the subsea cable unit catenary does not force the subsea cable unit 18 to reposition. This feature also ensures that the tension in the subsea cable unit 18, is not transferred to the subsea cable unit 18 on the opposite side of the stabilizing device 22.

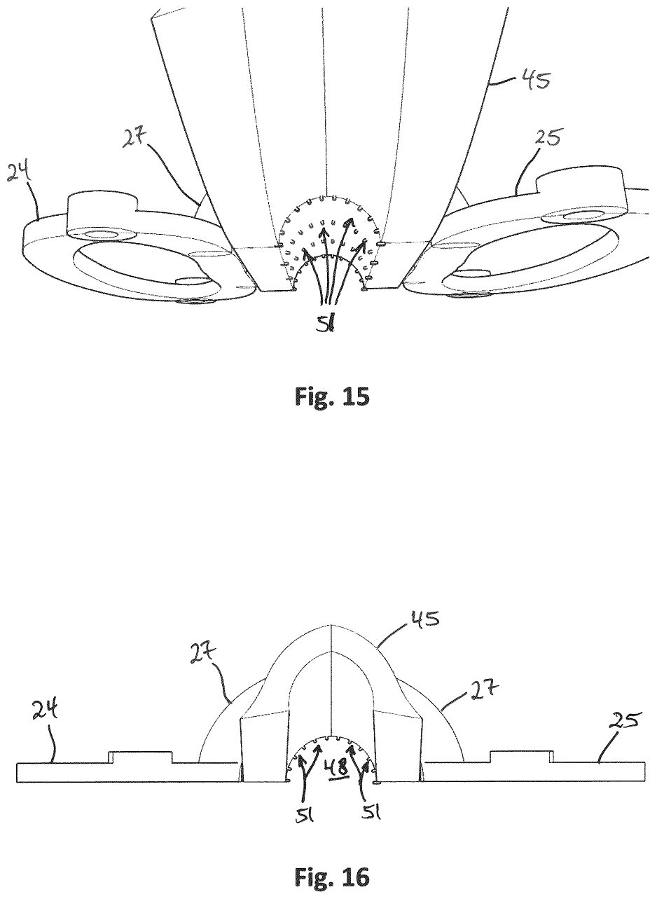

Longitudinal arresting of the subsea cable unit 18 can be obtained by a motion arresting element 51, as illustrated in FIGS. 15 and 16, for example in the form of a high friction layer inside the horizontal part 48 of the dome-shaped cowl unit 45. The entire ceiling of the cowl unit 45 can be fitted with a high friction material or substance (e.g., but not limited to natural rubber, neoprene preferably to EDS-6 Hardness grades 67,73 and 78).

The friction may also be provided by motion arresting elements 51 in the form of panels or friction pads inside the domed ceiling of the cowl unit 45 as indicated in FIGS. 15 and 16, compressing against the subsea cable unit 18 while the domed cowl unit 45 is stabilized onto the seabed 17 or scour protection layer 15. Thus, the subsea cable unit 18 is forced against the friction pads after dropping onto the cable protection system 20 of the subsea cable unit 18 from the vertical foundation force on the at least one stabilization base 24, 25. This increases the friction and secures the subsea cable unit 18 from sliding and transferring tension from the stabilizing device 22.

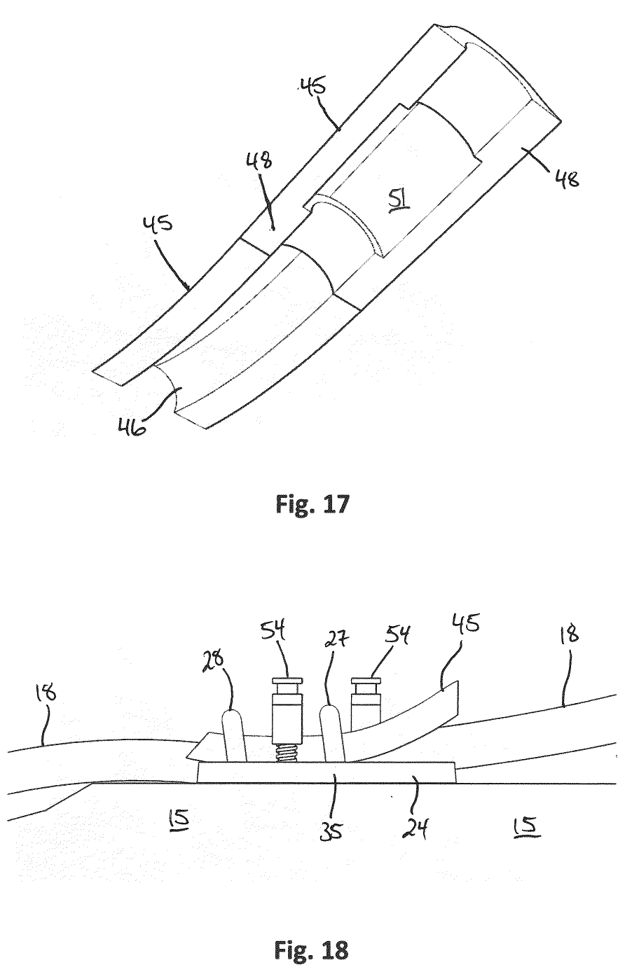

Alternatively, as illustrated in FIG. 17, the subsea cable unit 18 may be arrested inside the dome-shaped cowl unit 45, preferably within the horizontal part 48 of the cowl unit 45, with a motion arresting element 51 in the form of a slot/cavity/groove/recess that is adapted to be interfaced with a particular length section of the subsea cable unit 18.

As illustrated in FIG. 18, the stabilizing device 22 may be positioned near or on top of the touch-down point 34 of the subsea cable unit 18. In this figure, the stabilizing device 22 is shown cantered on top of the subsea cable unit 18 touchdown. This will require a high degree of installation accuracy. To allow freedom of installation position relative to the touch down point 34 of the subsea cable unit 18, the flexibility of the bending management system is adapted to tolerate wide tolerances.

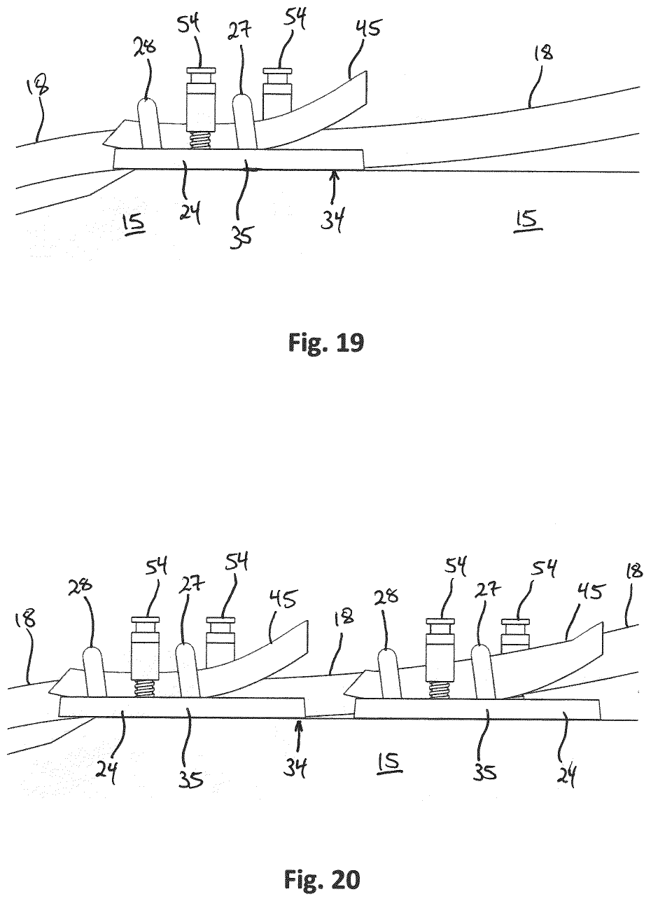

In FIG. 19, the center 31 of the stabilizing device 22 is positioned outside the touch-down point 34 of the subsea cable unit 18. The capacity of the bending management system can be designed to accommodate a required maximum horizontal outside positioning.

Alternatively, the center 35 of the stabilizing device 22 can be positioned inside the touch-down-point 34 of the subsea cable unit 18. The capacity of the bending management system can be designed to accommodate required minimum horizontal inside positioning.

As shown in FIG. 20, this facilitates a large degree of freedom for horizontal positioning of the stabilizing device 22 on top of the subsea cable unit 18 as shown with two alternative positions of the center 35 of the stabilizing device 22. This horizontal freedom also allows variable cable protection system and cable direction (compass direction).

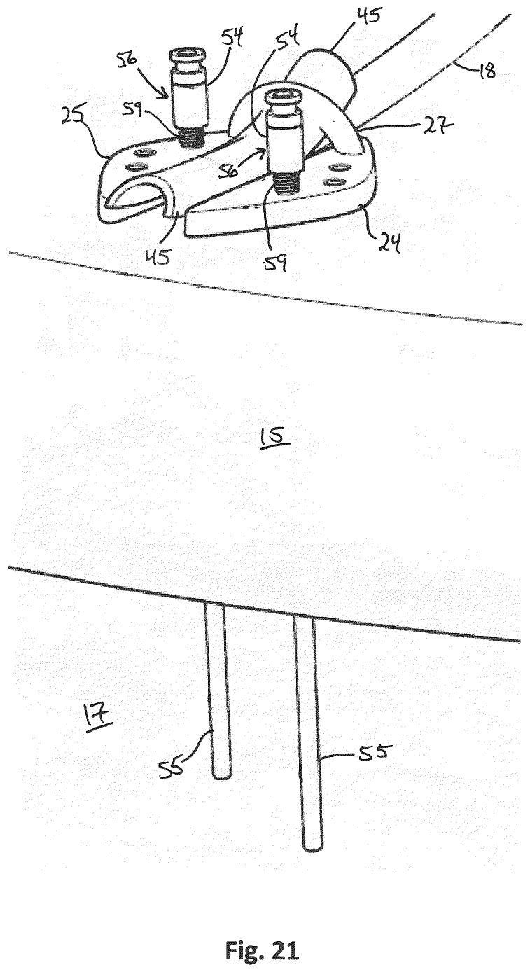

As illustrated in FIG. 21, for the open alternatives of the stabilization base 24, 25, a boxed in first stabilization base 24 and second stabilization base 25 may be arranged on each side of the cowl unit 45 of the bending management system on top of the subsea cable unit 18.

With one or more pile elements 54 extending from the top of the stabilization bases 24, 25 and to a depth deep into stable seabed as indicated by reference number 17, e.g., through the scour-protection layer 15.

As shown in FIG. 22, the through-holes 42 for pile elements 54 in the at least one stabilization base 24, 25, may be equipped with a guide element 43 to assist the pile elements 54 in entering their respective through-holes 42.

The compression system of the stabilizing device 22, comprising an expansion device 59, may, as indicated in FIG. 23, during driving of the foundation type (i.e., the pile elements 54 or screws etc.), be compressed from a relaxed state 61 with a non-compressed length of the expansion device 59, to a compressed state 60 with a compressed length. Alternatively, the expansion device 59 may be applied in its compressed length to have the capacity to expand towards its non-compressed length.

In case of seabed 17 mobility, or scour-protection 15 setting deeper into the seabed 17, the compressed installation lengths of the expansion device 59, can expand from compressed length of the expansion device towards full length of the expansion device 59. This expansion length is the vertical drop capacity that the stabilizing device can follow a seabed 17 or scour-protection 15 drop.

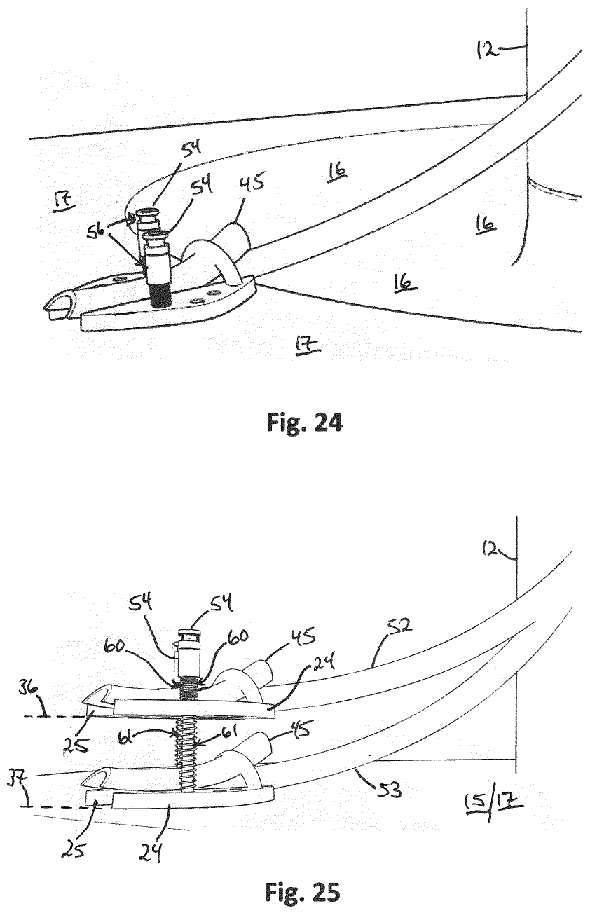

As illustrated in FIG. 24, the compressed expansion device 59, releases its expansion as a force downwards onto the at least one stabilization base 24, 25 and upwards towards the top portion 56 of the pile elements 54. In this figure, the stabilization device 22 is shown in seabed 17 without scour-protection 15, with scour pit/scour hole 16 developing near the monopile 12.

FIG. 25 illustrates that from installation level 36 of the stabilizing device 22 on what were the seabed level at the time of installation, onto the first catenary 52 of the seabed cable unit 18, with compressed expansion devices 59, the stabilizing device 22 will follow the drop in seabed level all the way to the lowered level of the stabilizing device 22, during which the expansion device 59 will elongate from the compressed state 60 to a more relaxed state 61 with new expanded lengths, thus forcing the at least one stabilization base 24, 25 to move from the installation level 36 of the stabilizing device 22 to a lowered level 37 of the stabilization device 22 to the new lowered seabed height, forcing the subsea cable unit 18 into a new, second catenary shape 53.

This will move the touch-down point 34 of the natura catenary shape of the subsea cable unit 18, but the capacity of the bending management system retains control over this, despite a higher tension on the second subsea cable unit catenary 53.

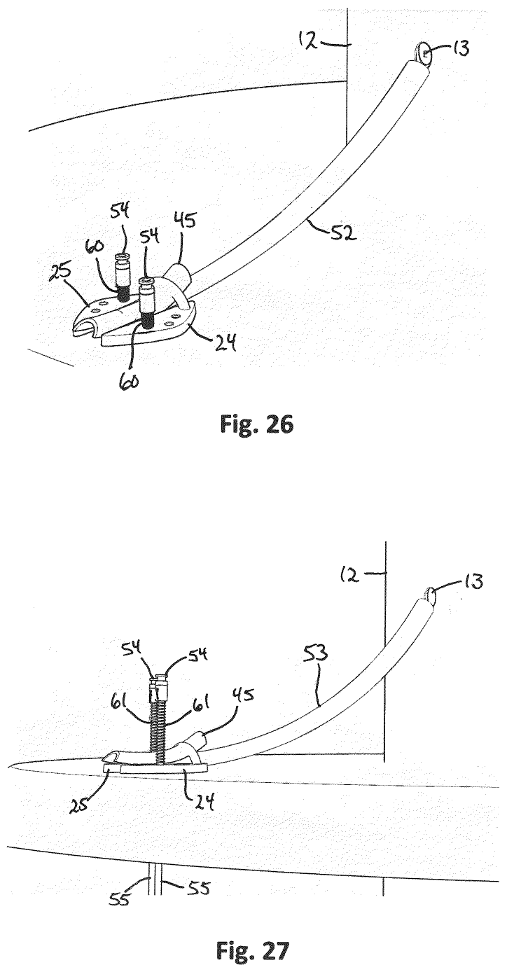

In FIG. 26, the original seabed 17 (state and position of seabed 17 at the time of installation of the stabilizing device 22) of the stabilizing device 22 is illustrated. The at least one stabilization base 24, 25 is arranged over the subsea cable unit 18 with its first catenary shape 52, fixed by pile elements 54 into the seabed, with expansion devices 59 in their compressed states 60.

As illustrated in FIG. 27, in the event of a drop in seabed/scour-protection height, the pile elements 54, both top portions 56 and submerged lower parts 55, remain unchanged. Hence, when the seabed 17 drops, the at least one stabilization base 24, 25 follows the level of the seabed 17 due to the expansion of the compressed expansion device 59, and leaving the height of the top portions 56 of the pile elements 54 equally raised above the at least one stabilization base 24, 25, as the level of the seabed 17 drops.

The expansion device 59 may preferably be arranged with compression springs (as indicated above and in the figures) or it may be arranged with any expanding material, which can be installed or compressed in its retracted form. Thus, either mechanical restriction may cease after installation (degradable after submerged after pre-determined time, or the expansion of a base material is facilitated by the submerging into seawater.

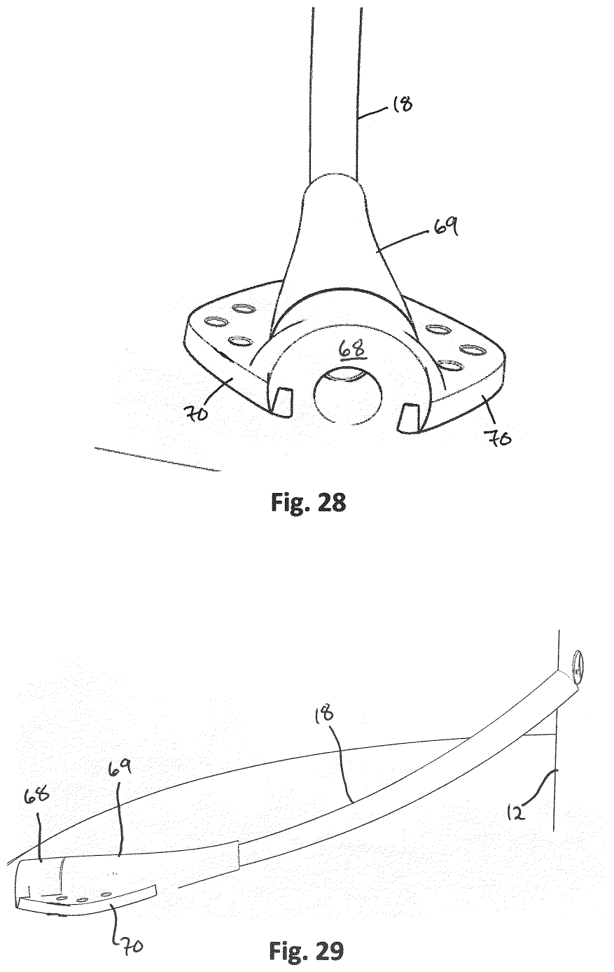

As illustrated in FIGS. 28 and 29, the bending management system of the stabilizing device 22 can be arranged as, for example, a bending strain relief type bend stiffener known from API 17. The bending strain relief base 68 is fixed, alternatively integrated, into the stabilization base 70. The bend stiffener section 69 of the bending management system provides a required sequential increase in bending stiffness from the raised tip (where it has least bending stiffness) toward the solid base with increasing bending stiffness.

The bending strain relief arrangement can be pre-installed onto the cable protection system prior to pull-in. An alternative and preferred method will be with an open slot bending strain relief base 68 and bend stiffening section 69, allowing the stabilizing device 22 to be placed on top of the subsea cable unit 18. Apart from the installation operational advantages separating the stabilizing device 22 from running in the critical path and in CLS's cable highway, this also allows stabilization with a stabilizing device 22 onto installed subsea cable units 18.

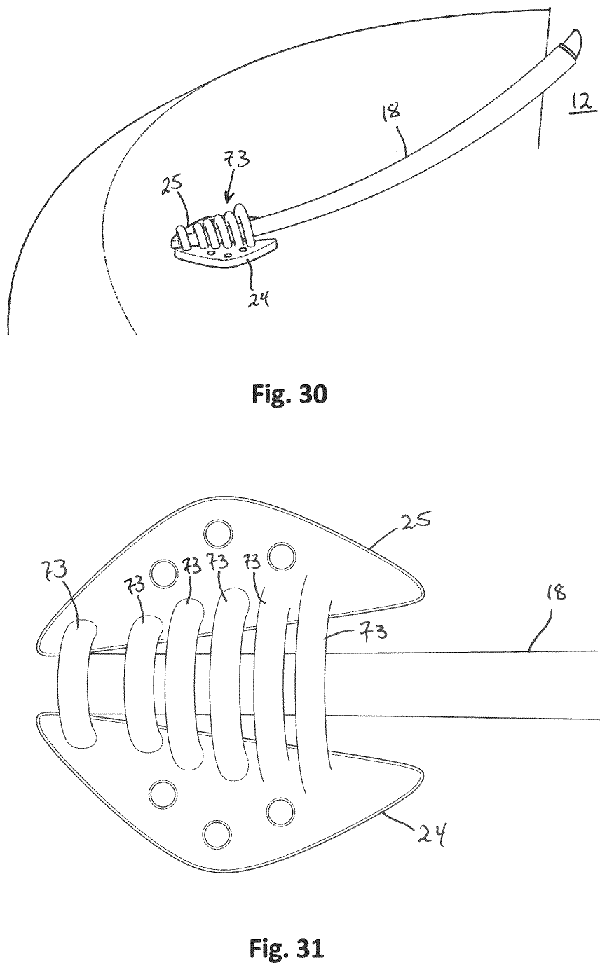

As illustrated in FIGS. 30-31, the bending management system can alternatively be arranged as a gradually restriction in the subsea cable unit 18 free movement. This can be arranged as a trumpet shaped half-cone 72, preferably in a series of bars 73 as a function of their inner shape, or as a function of their structural stiffness, or any combination thereof. Preferably the arrangement can be made with a single or multiple rigid bars or similar arrangement to provide area for the tension strain management.

The longitudinal friction lips provide upwards force on the cable protection system 20, towards the friction pads/layer, and provides a slight deformation on both sides of the cable protection system to secure the grip onto a slick cable protection system surface.

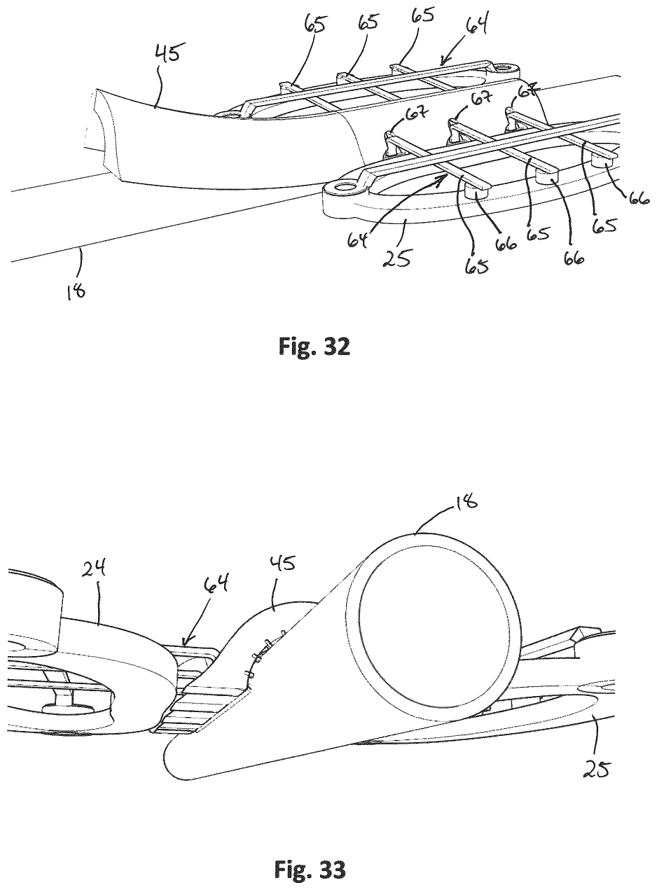

As illustrated in FIG. 32, the stabilizing device 22 may be provided with a deformation device 64 that positively deform the outer surface of the cable protection system 20 of the subsea cable unit 18 to reinforce longitudinal arresting, alone or in combination with any other motion arresting element 51, such as friction pads/layers as explained above.

The transversely arranged, relative to the longitudinal direction of the cowl unit 45, transverse stays 65 (for example, three on each side, but there may be one or more transverse stays 65), are in one end securely attached to the cowl unit 45 at respective attachment points 67 and will be pushed down onto the at first and second stabilization bases 24, 25 by the pile elements 54 and their expansion devices 59. The other ends of the transverse stays 65 are linked to a compression area 66 or pad area arranged on the first and second stabilization bases 24, 25. When the transverse stays 65 are not forced down, the compression area 66 remains in a substantially horizontal position, allowing it to fit over the cable protection system 20 of the subsea cable unit 18.

When the pile elements 54 applies pressure onto the transverse stays 65 and in turn on the first and second stabilization bases 24, 25, the other end of the transverse stays 65 push onto the surface of the cable protection system 20 of the subsea cable unit 18 as indicated in FIG. 33. This provides a tight grip onto the outer surface of the cable protection system 20, preventing the subsea cable unit 18 from any movements.

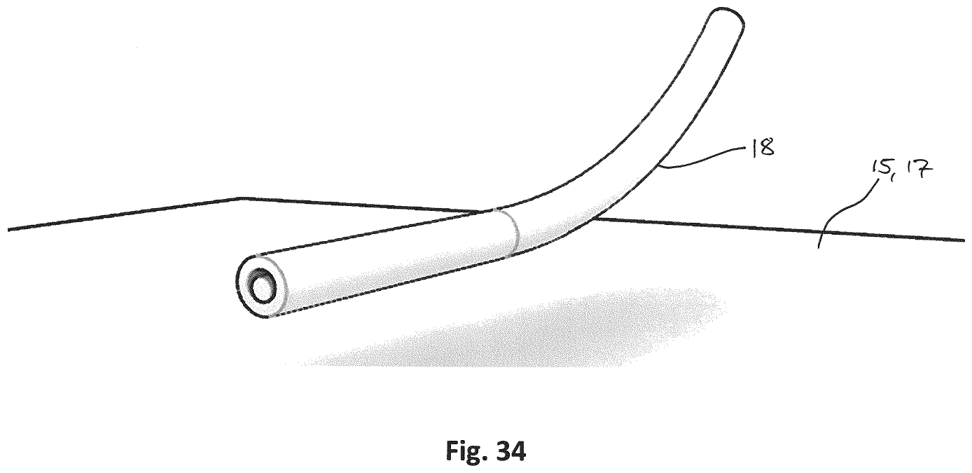

In FIGS. 34-40 there is illustrated an alternative foundation device 74 for a subsea cable unit 18, which comprises a cable only or a cable provided with a cable protection system, to mitigate the dropping the seabed 17 and/or the scour protection layer 15 without changing the catenary shape of the subsea cable unit 18 that is installed. Such dropping of the seabed and/or the scour protection layer may arise from erosion or scouring of the seabed locally below the subsea cable unit 18 or globally in the area around the subsea cable unit 18. This alternative foundation device 74 further has the advantage of enabling installation of the subsea cable unit 18 in positions where erosion have created a free-span of the subsea cable unit 18 between the touch-down point of the subsea cable unit 18 when it was built and the original pre-erosion seabed level or scour layer level. Thus, the alternative foundation device 74 enables the subsea cable unit 18 to be installed as it is suspended above the seabed level 17 or the level of the scour protection layer 15, providing an artificial touch-down base for the subsea cable unit 18 that is elevated above the seabed level or level of the scour protection layer without changing the catenary shape and therefor the tension in the subsea cable unit 18.

The foundation device 74 may also be used in cases where it is expected that erosion will occur due to local water current conditions. The foundation devices 74 are then installed prior to the installation of the subsea cable unit 18 or in the same installation process as the subsea cable unit 18.

In FIG. 34 there is shown a subsea cable unit 18 which is installed and extends from a position above the level of the seabed 17 or the scour protection layer 15, for example from a subsea structure (not shown in the figure), and down to the seabed 17 or scour protection layer 15.

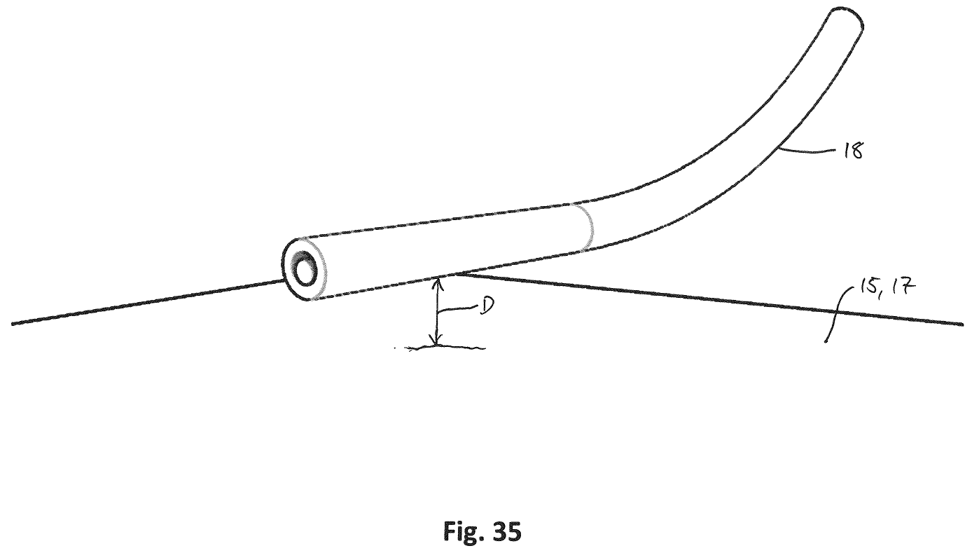

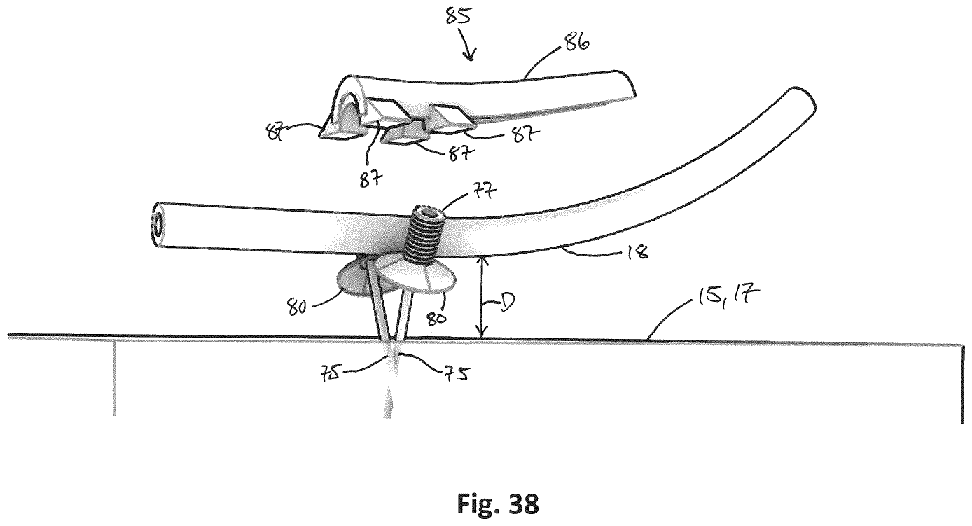

With time, erosion of the seabed 17 and/or the scour protection layer 15 may take place and the subsea cable unit 18 may end up hanging above the seabed 17 or the scour protection layer 15. This is indicated in FIGS. 35 and 38 where the subsea cable unit 18 is located a distance D above the seabed 17 or the scour protection layer 15. This will increase tension in the subsea cable unit 18 and may cause a change in the catenary shape of the subsea cable unit 18 and therefore increased wear on the subsea cable unit 18.

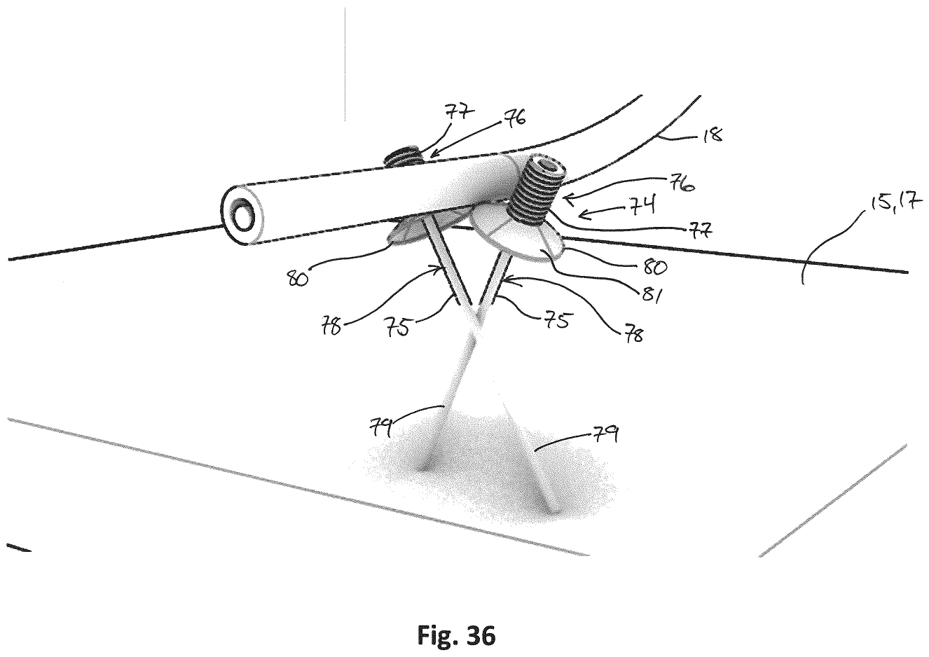

In FIGS. 36-40 a foundation device 75 is illustrated which can be used to mitigate the problem of erosion of the seabed 17 and/or the scour protection layer 15 around the subsea cable unit 18.

In FIG. 36 there is shown two foundation devices 75 each comprising pile element 75 with a lower portion 79 which is arranged in the seabed 17 and/or the scour protection layer 15, an upper portion 76 and a free portion 78 between the lower portion 79 and the upper portion 76.

The upper portion 76 of the pile elements 75 are provided with attachment unit 77. The attachment unit 77 is securely attached to the pile elements 75 with suitable means, such as bolts or by welding.

Each foundation device 74 further comprises a support element 80 which is attached to the attachment unit 77 and supports the subsea cable unit 18. The support element 80 is preferably adjustably attached to the attachment unit 77 but may also be securely attached to the attachment unit with bolts or any other suitable fastening means. To obtain a support element 80 that is adjustably arranged on the attachment unit 77, the support element 80 and the attachment unit 77 can be provided with corresponding threads such that the support element 80 can be screwed up and down on the attachment unit 77 to a desired position. When the support element 80 is arranged in its desired position, it may be locked to the attachment unit 77 with a suitable locking mechanism (not shown in the figure).

The support elements 80 are preferably provided with a support element support surface 81 which is conically shaped as shown in the figures. Since the pile elements 75 are arranged in the seabed 17 and/or the scour protection layer 15 inclined relative to a vertical line, the angle of the conically shaped support element support surface 81 may be adapted to the angle of inclination of the pile elements 75 such that the subsea cable unit 18 rests on a surface that is substantially horizontal.

As can be clearly seen in FIG. 36, two foundation devices have been installed inclined relative to each other and the seabed 17 or the scour protection layer 15 such that they form the shape of a pair of scissors. Furthermore, the subsea cable unit 18 rests on the support element support surfaces 81 of the support elements 80.

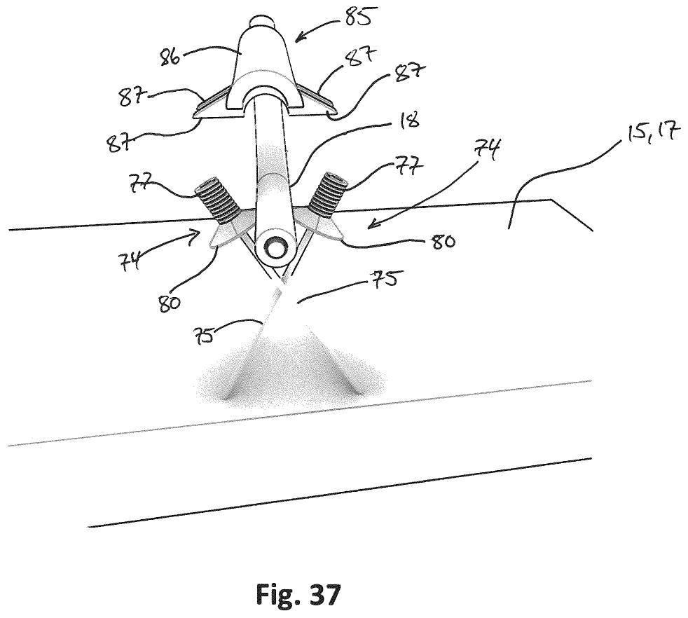

FIGS. 37 and 38 further illustrates the installation of a bend stiffener unit 85. The bend stiffener unit 85 comprises a bend stiffener body 86 which has a roughly half-dome shaped cross-section and fits on top of the subsea cable unit 18. In FIG. 38 it is clearly shown that the subsea cable unit 18 is supported by the support elements 80 at a distance D above the level of the seabed 17 or the scour protection layer 15.

The bend stiffener unit 85 further comprises four attachment elements 87 which are securely attached to the bend stiffener body 86 and extend outwards from the bend stiffener body 86 as indicated in the figures. Two attachment elements 87 are arranged on either side of the bend stiffener body 86 as indicated in the figures. The distance in the longitudinal direction of the bend stiffener body 86, between the two attachment elements 87 on the same side of the bend stiffener body 86, is adapted so that the attachment unit 77 and a locking element 82 fit in the space between the two attachment elements 87.

The bend stiffener unit 85 will control the bending of the subsea cable unit 18 once it is installed and reduce the risk of damage to the subsea cable unit 18.

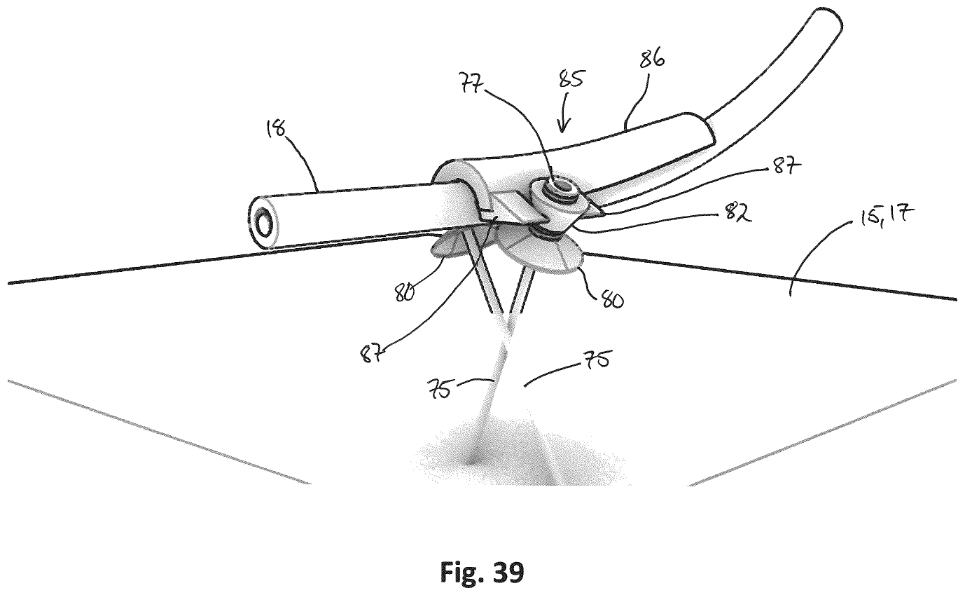

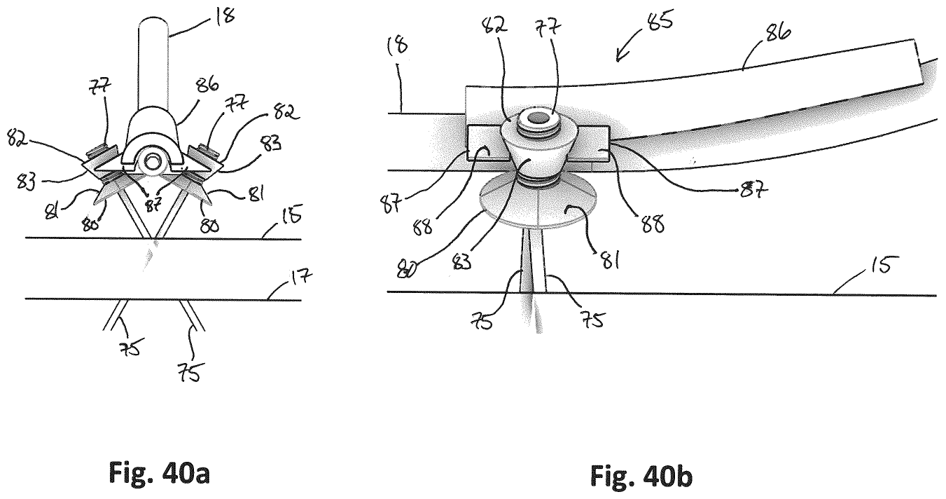

FIGS. 39 and 40a-40b shows bend stiffener unit 85 arranged on top of the subsea cable unit 18. As mentioned above, the bend stiffener body 86 of the bend stiffener unit 85 is half-dome shaped and fits on top of the subsea cable unit 18.

When the bend stiffener unit 85 is arranged on top of the subsea cable unit 18, a locking element 82 is arranged on the attachment unit 77 such that the bend stiffener unit 85, and thus the subsea cable unit 18, is locked in their positions.

The locking element 82 is preferably adjustably arranged on the attachment unit 77 in the longitudinal direction of the pile element 75. The locking element 82 and the attachment unit 77 can, for example, be provided with corresponding threads such that the locking element 82 can be screwed up and down along the attachment unit 77 to a desired position where the bend stiffener unit 85 is locked in its position on top of the subsea cable unit 18. When the locking element 82 is arranged in its desired position, it may be locked to the attachment unit 77 with a suitable locking mechanism (not shown in the figure).

The attachment elements 87 are preferably wedge-shaped and provided with an attachment element contact surface 88 as indicated in the figures. Furthermore, the locking element 82 has locking element contact surface 83 which is conically shaped and abuts the attachment elements 82 located on the opposite sides of the locking element 82 after installation of the bend stiffener unit 85. The wedge-shaped attachment elements 87 ensures an advantageous angle and therefore a better cooperation between the locking member contact surface 83 and the attachment element contact surface 88.

Reference numbers used in the description of the figures:

| | |
|---|---|
| 10 | Subsea system |
| 11 | Subsea structure |
| 12 | Monopile/monopile foundation |
| 13 | Cable entrance/aperture hole (in monopile for subsea cable |
| | unit) |
| 14 | Connector/latch/interface-unit (of the cable protection system |
| | at the cable entrance/aperture) |
| 15 | Scour protection layer |
| 16 | Scour pit/scour hole |
| 17 | Seabed |
| 18 | Subsea cable unit |
| 19 | Cable |
| 20 | Cable protection system |
| 22 | Stabilizing device |
| 24 | First stabilization base |
| 25 | Second stablilization base |
| 26 | Stabilization plane (of first and/or second stabilization base) |
| 27 | First clamping device |
| 28 | Second clamping device |
| 30 | Absorber device (comprised in first and/or second clamping |
| | device) |
| 31 | First anchor section (for attachment of absorber device on the |
| | first and/or second stabilization device) |
| 32 | Second anchor section (for attachment of absorber device on |
| | the cowl unit) |
| 34 | Touch-down point (of the subsea cable unit on the seabed or |
| | on the scour protection) |
| 35 | Centre of stabilizing device (can be on/near or outside or |
| | inside of the touch-down point of the subsea cable unit) |
| 36 | Installation level of stabilization device (the level of the seabed |
| | or scour protection at the time of installation) |
| 37 | Lowered level of stabilization device (after a drop of the seabed |
| | level) |
| 39 | Clamp element |
| 40 | Groove (in clamp element) |
| 42 | Through-hole (in first and/or second stabilization base or clamp |
| | element for a pile element) |
| 43 | Guide element (for a pile element for |
| 45 | Cowl unit |
| 46 | Tip ((flexible) tip of the cowl unit) |
| 47 | Dome center (of the cowl unit) |
| 48 | Horizontal part (of the cowl unit) |
| 49 | Side part (of the cowl unit) |
| 51 | Motion arresting element (Friction pads/friction layer provided |
| | in cowl unit to arrest motion of the subsea cable unit or Slot/ |
| | cavity/groove/recess (in horizontal part of cowl unit to arrest |
| | motion of the subsea cable unit)). |
| 52 | First catenary (of seabed cable unit at the time of installation) |
| 53 | Second catenary (of seabed cable unit after drop in level of |
| | seabed) |
| 54 | Pile element |
| 55 | Lower part (penetrated into the scour protection and/or the |
| | seabed) |
| 56 | Top portion |
| 57 | Handling interface (for an ROV) |
| 59 | Expansion device |
| 60 | Compressed state (of the expansion device) |
| 61 | Relaxed state (of the expansion device) |
| 62 | Adjustment device (for adjustment of tension of the expansion |
| | device) |
| 64 | Deformation device |
| 65 | Transverse stay |
| 66 | Compression area (on stabilization base) |
| 67 | Attachment point (of transverse stay to cowl unit) |
| 68 | Bending strain relief base |
| 69 | Bend stiffener section |
| 70 | Stabilization base (integrated with bending strain relief base |
| | and/or bend stiffener section) |
| 72 | Trumpet shaped half-cone (instead of cowl unit) |
| 73 | Bar |
| 74 | Foundation device (comprising a pile element with an |
| | attachment unit and a support element and a locking element |
| | adapted to mounted on to the attachment unit) |
| 75 | Pile element (to be driven into the seabed and/or the scour |
| | protection layer) |
| 76 | Upper portion (of the pile elements) |
| 77 | Attachment unit (mounted on the upper portion of the pile |
| | elements for attachment of support element and locking element, |
| | for example with corresponding threaded portions on the |
| | attachment unit and the support element and/or locking element) |
| 78 | Free portion (of the pile elements - the portion between the |
| | upper portion and the seabed or scour layer) |
| 79 | Lower portion (of the pile elements, arranged in the seabed |
| | and/or the scour layer) |
| 80 | Support element (which is arranged on the attachment unit of |
| | the pile element and provides support for the subsea cable unit) |
| 81 | Support element support surface (of the support element - can |
| | be provided with a conical shape on which the subsea cable |
| | unit rests) |
| 82 | Locking element (which is arranged on the attachment unit of |
| | the pile element above the support element and locks the |
| | subsea cable unit and bend stiffener unit in their positions) |
| 83 | Locking element contact surface (of the locking element - can |
| | be provided with a conical surface which abuts the attachment |
| | element) |
| 85 | Bend stiffener unit (controls the bending of the subsea cable |
| | unit) |
| 86 | Bend stiffener body |
| 87 | Attachment element (attached to the bend stiffener unit and |
| | adapted/shaped to be arranged between the support element |
| | and the locking element on the foundation piles and locking |
| | the bend stiffener unit in its position on the subsea cable unit) |
| 88 | Attachment element contact surface (of the attachment |
| | element - can be provided with a conical shape which abuts |
| | the locking element) |

1. A stabilizing device for a subsea cable unit extending between the seabed and a cable entrance on a subsea structure where the cable entrance is located above the seabed, wherein the subsea cable unit comprises a subsea cable with a cable protective system or a subsea cable only, and wherein the stabilizing device comprises:
at least one stabilization base;
a first clamping device which is securely attached to the at least one stabilization base in one end, the first clamping device being curved and adapted to at least partially surround the subsea cable unit and hold the subsea cable unit when the at least one stabilizing device and the subsea cable unit are installed,
a second clamping device which is securely attached to the at least one stabilization base in one end, the second clamping device being curved and adapted to at least partially surround the subsea cable unit and hold the subsea cable unit when the stabilizing device and the subsea cable unit are installed, and
at least one pile element for anchoring of the at least one stabilization base to the seabed or a scour protection layer, the at least one pile element being adapted to be driven into the seabed or scour protection layer such that the at least one stabilization base is securely anchored to the seabed or the scour protection layer , and such that the stabilizing device is positioned on top of the touch-down point of the subsea cable unit when the stabilizing device is installed.

2. The stabilizing device according to claim 1,
wherein the first clamping device and the second clamping device are attached to the at least one stabilization base so that the first clamping device is closer to the subsea structure than the second clamping device, and wherein the first clamping device is flexible.

3. The stabilizing device according to claim 1,
wherein the second clamping device is more rigid than the first clamping device.

4. The stabilizing device according to claim 1,
wherein the at least one stabilization base comprises at least one through-hole through which the at least one pile element is adapted to be passed.

5. The stabilizing device according to claim 1,
wherein the stabilizing device comprises at least one clamp element which comprises at least one through-hole for the at least one pile element.

6. The stabilizing device according to claim 1,
wherein the at least one pile element is provided with an expansion device which exerts a force on the at least one stabilization base towards the seabed or the scour protection layer.

7. The stabilizing device according to claim 6,
wherein the expansion device is adapted to expand if the seabed or scour protection layer is eroded in order to exert a continuous force on the at least one stabilization base towards the seabed or the scour protection layer.

8. The stabilizing device according to claim 6,
wherein the at least one pile element is provided with an adjustment device for adjustment of the tension in the expansion device and thereby the force exerted on the at least one stabilization base.

9. The stabilizing device according to claim 1,
wherein the stabilizing device further comprises a cowl unit for bending control of the subsea cable unit, wherein the cowl is curved and at least partially surrounds the subsea cable unit in a circumferential direction of the subsea cable unit, and the cowl unit and the subsea cable unit is held by the first clamping device and the second clamping device.

10. The stabilizing device according to claim 9,
wherein the cowl unit is further curved in the longitudinal direction of the subsea cable unit to prevent bending of the cable beyond a desired angle.

11. The stabilizing device according to claim 9, wherein the cowl unit is provided with at least one motion arresting element on the side facing the subsea cable unit, where the at least one motion arresting element presses against the subsea cable unit.

12. The stabilizing device according to claim 1,
wherein the stabilizing device comprises a first stabilization base and a second stabilization base , each comprising at least one through-hole for a at least one pile element which is adapted to fit in the at least one through-hole and to be driven into the seabed or the scour protection layer such that the first stabilization base and the second stabilization base can be securely anchored to the seabed or the scour protection layer.

13. The stabilizing device according to claim 12,
wherein the first clamping device is securely attached to the first stabilization base in one end and to the second stabilization base in the other end, and the second clamping device is securely attached to the first stabilization base in one end and to the second stabilization base in the other end.

14. The stabilizing device according to claim 1,
wherein the first clamping device comprises at least one dynamic absorber device which is anchored to the first stabilization base and/or the second stabilization base in one end and to the cowl unit in the other end.

15. The stabilizing device according to claim 12,
wherein the first stabilization base and/or the second stabilization base are provided with a plurality of through-holes for pile elements which are adapted to fit in respective through-holes and to be driven into the seabed or the scour protection layer such that the first stabilization base and/or the second stabilization base can be securely anchored to the seabed by a plurality of pile elements.

16. The stabilizing device according to claim 4,
wherein the at least one through-hole is/are provided with a guide element to facilitate the entering of the at least one pile element into the at least one through-hole during installation of the stabilizing device.

17. The stabilizing device according to claim 1,
wherein the at least one pile element is adapted for handling by an ROV.

18. The stabilizing device according to claim 1,
wherein the subsea cable unit is provided with a cable protective system.

19. The stabilizing device according to claim 1,
wherein the subsea structure is securely mounted in or to the seabed.

20. A subsea system comprising a subsea structure which is securely mounted in or to the seabed, and a subsea cable unit which extends between the seabed and a cable entrance on the subsea structure where the cable entrance is located above the seabed, wherein the subsea cable unit comprises a subsea cable with a cable protective system or a subsea cable only, and wherein the subsea system comprises the stabilizing device according to claim 1 for stabilization of the subsea cable unit.

21. The subsea system according to claim 20, wherein the stabilizing device is arranged on a scour protection layer which is arranged on the seabed adjacent the subsea structure.

22. The subsea system according to claim 20, wherein the stabilizing device is arranged directly on the seabed.

23. The subsea system according to claim 20,
wherein the subsea structure is a monopile of a wind power plant which is securely mounted to or in the seabed.

24. Use of the stabilizing device according to claim 1, to stabilize a subsea cable unit from an offshore wind power plant.

25. Use of a subsea system according to claim 20, to stabilize a subsea cable unit from an offshore wind power plant.
